(19) United States
(12) Patent Application Publication
(10) Pub. No.: US 2026/0063759 A1
(43) Pub. Date: Mar. 5, 2026

(54) RADAR DEVICE

(71) Applicant: DENSO CORPORATION, Kariya-city (JP)

(72) Inventors: SATORU SHIMIZU, Kariya-city (JP); CHIHIRO ARAI, Kariya-city (JP); YUKOU MURASE, Kariya-city (JP); OSAMU ISAJI, Kariya-city (JP)

(21) Appl. No.: 19/379,425

(22) Filed: Nov. 4, 2025

Related U.S. Application Data
(63) Continuation of application No. PCT/JP2024/014488, filed on Apr. 10, 2024.

(30) Foreign Application Priority Data
May 8, 2023 (JP) 2023-076807

(51) Int. Cl. G01S 7/40; G01S 7/35

(52) U.S. Cl. CPC G01S 7/4021; G01S 7/352

(57) ABSTRACT

A radar device includes a plurality of transmission antennas, a plurality of reception antennas, a number Ns of transmission circuits connected to the transmission antennas and configured to output a transmission signal, a number Nr of reception circuits connected to the reception antennas and configured to acquire reception signals, a control unit configured to process the reception signals, and a housing unit configured to house the transmission antennas, the reception antennas, the transmission circuits, the reception circuits, and the control unit. The control unit is configured to acquire error information relating to at least one of the phase difference and amplitude difference of the reception signals corresponding to a wiring length difference between the virtual antennas, and estimate temperature information related to internal temperature of the housing unit according to the error information.

### CROSS REFERENCE TO RELATED APPLICATION

The present application is a continuation application of International Patent Application No. PCT/JP2024/014488 filed on Apr. 10, 2024 which designated the U.S. and claims the benefit of priority from Japanese Patent Application No. 2023-076807 filed on May 8, 2023. The entire disclosures of all of the above applications are incorporated herein by reference.

### TECHNICAL FIELD

The present disclosure relates to radar technology.

### BACKGROUND

A related art discloses a radar device. This radar device includes a plurality of element antennas arranged on a planar plate, a temperature sensor, and a signal processing unit. The signal processing unit monitors the internal temperature of the main body by means of the temperature sensor. The signal processing unit determines a distance error between the element antennas caused by thermal expansion of the planar plate, based on temperature correction data stored in advance. The signal processing unit calculates a phase correction amount in the reception signal of each element antenna based on the distance error.

### SUMMARY

According to an aspect of the present disclosure, a radar device includes a plurality of transmission antennas; a plurality of reception antennas; a number Ns of transmission circuits connected to the transmission antennas and configured to output a transmission signal; a number Nr of reception circuits connected to the reception antennas and configured to acquire reception signals; a control unit configured to process the reception signals; and a housing unit configured to house the transmission antennas, the reception antennas, the transmission circuits, the reception circuits, and the control unit. Ns and Nr are each integers of 2 or more. The plurality of the transmission antennas and the plurality of the reception antennas may be arranged such that: (i) at least one of the plurality of the transmission antennas and the plurality of the reception antennas is arranged at unequal intervals; (ii) among a group of virtual antennas assumed for each transmission antenna with respect to the plurality of reception antennas according to a phase difference of the reception signals between the reception antennas, in a collection of sets of the virtual antennas in which virtual positions overlap and a combination of a transmission circuit and a reception circuit do not match, there are included at least Ns+N−2 unique sets of virtual antennas, each being a set in which a combination of a transmission circuit and a reception circuit does not overlap with any other set; (iii) at least one different wiring length set is included, which is a set of virtual antennas with overlapping virtual positions and different wiring lengths; and (iv) a total number of belonging sets, which are sets of virtual antennas belonging to at least one of the unique sets and the different wiring length set, is at least Ns+Nr−1 sets. The control unit may include: an error acquisition unit configured to acquire error information relating to at least one of the phase difference and amplitude difference of the reception signals corresponding to a wiring length difference between the virtual antennas, based on a comparison result of the reception signals between the virtual antennas in the at least Ns+Nr−1 belonging sets; and an estimation unit configured to estimate temperature information related to internal temperature of the housing unit according to the error information.

### BRIEF DESCRIPTION OF DRAWINGS

Objects, features and advantages of the present disclosure will become more apparent from the following detailed description made with reference to the accompanying drawings. In the drawings:

FIG. 1 is a schematic diagram showing the basic configuration of the radar device according to the first embodiment;

FIG. 2 is a schematic diagram illustrating an example of combinations of transmission circuits and transmission antennas, and reception circuits and reception antennas, in the first embodiment;

FIG. 3 is a schematic diagram showing an example of the arrangement of a transmission antenna and a reception antenna in the first embodiment;

FIG. 4 is a schematic diagram illustrating the assumed virtual antennas in the first embodiment;

FIG. 5 is a block diagram showing the functional configuration of the control unit according to the first embodiment;

FIG. 6 is a flowchart showing the control flow according to the first embodiment;

FIG. 7 is a flowchart showing a continuation of the control flow;

FIG. 8 is a graph showing an example of the relationship between wiring length difference and phase error;

FIG. 9 is a graph showing an example of the relationship between parameters related to phase error and temperature;

FIG. 10 is a table showing an example of sets of virtual antennas used for compensation processing;

FIG. 11 is a graph showing the relationship between phase error among transmission circuits and temperature;

FIG. 12 is a graph showing the relationship between phase error among reception circuits and temperature;

FIG. 13 is a schematic diagram showing an example of the arrangement of transmission antennas and reception antennas in the second embodiment;

FIG. 14 is a schematic diagram illustrating the assumed virtual antennas in the second embodiment;

FIG. 15 is a schematic diagram showing an example of the arrangement of transmission antennas and reception antennas in the third embodiment;

FIG. 16 is a schematic diagram illustrating the assumed virtual antennas in the third embodiment;

FIG. 17 is a table showing an example of sets of virtual antennas used for compensation processing;

FIG. 18 is a schematic diagram illustrating an example of combinations of transmission circuits and transmission antennas, and reception circuits and reception antennas, in the third embodiment;

FIG. 19 is a schematic diagram showing an example of the arrangement of transmission antennas and reception antennas in the third embodiment;

FIG. 20 is a schematic diagram illustrating the assumed virtual antennas in the third embodiment; and

FIG. 21 is a graph showing the relative relationship of wiring lengths among the assumed virtual antennas in the third embodiment.

### DETAILED DESCRIPTION

Generally, a thermistor is used as the temperature sensor in radar devices such as those described in the related art. However, the thermistor may exhibit decreased sensitivity at low and high temperatures.

The present disclosure provides a radar device capable of temperature detection with suppressed sensitivity degradation.

According to one aspect of the present disclosure, A radar device comprises: a plurality of transmission antennas; a plurality of reception antennas; a number Ns of transmission circuits connected to the transmission antennas and configured to output a transmission signal; a number Nr of reception circuits connected to the reception antennas and configured to acquire reception signals; a control unit configured to process the reception signals; and a housing unit configured to house the transmission antennas, the reception antennas, the transmission circuits, the reception circuits, and the control unit. Ns and Nr are each integers of 2 or more. The plurality of the transmission antennas and the plurality of the reception antennas are arranged such that: (i) at least one of the plurality of the transmission antennas and the plurality of the reception antennas is arranged at unequal intervals; (ii) among a group of virtual antennas assumed for each transmission antenna with respect to the plurality of reception antennas according to a phase difference of the reception signals between the reception antennas, in a collection of sets of the virtual antennas in which virtual positions overlap and a combination of a transmission circuit and a reception circuit do not match, there are included at least (Ns+Nr−2) unique sets of virtual antennas, each being a set in which a combination of a transmission circuit and a reception circuit does not overlap with any other set; (iii) at least one different wiring length set is included, which is a set of virtual antennas with overlapping virtual positions and different wiring lengths; and (iv) a total number of belonging sets, which are sets of virtual antennas belonging to at least one of the unique sets and the different wiring length set, is at least (Ns+Nr−1) sets. The control unit includes: an error acquisition unit configured to acquire error information relating to at least one of the phase difference and amplitude difference of the reception signals corresponding to a wiring length difference between the virtual antennas, based on a comparison result of the reception signals between the virtual antennas in the at least (Ns+Nr−1) belonging sets; and an estimation unit configured to estimate temperature information related to internal temperature of the housing unit according to the error information.

According to one aspect of the present disclosure, a radar device comprises: a plurality of transmission antennas arranged at equal intervals; a plurality of reception antennas arranged at equal intervals; a number Ns of transmission circuits connected to the transmission antennas and configured to output a transmission signal; a number Nr of reception circuits connected to the reception antennas and configured to acquire reception signals; a control unit configured to process the reception signals; a housing unit configured to house the transmission antennas, the reception antennas, the transmission circuits, the reception circuits, and the control unit. Ns and Nr are each integers of 2 or more. The plurality of the transmission antennas and the plurality of the reception antennas are arranged such that: (i) among groups of virtual antennas assumed for each transmission antenna with respect to the plurality of reception antennas according to a phase difference of the reception signals between the reception antennas, in a collection of sets of the virtual antennas in which virtual positions overlap and a combination of a transmission circuit and a reception circuit do not match, there are included at least (Ns+Nr−2) unique sets of virtual antennas, each being a set in which a combination of the transmission circuit and the reception circuit does not overlap with any other set; (ii) at least one different wiring length set is included, which is a set of virtual antennas with overlapping virtual positions and different wiring lengths; and (iii) a total number of belonging sets, which are sets of virtual antennas belonging to at least one of the unique sets and the different wiring length set, is at least (Ns+Nr−1) sets. The control unit includes: an error acquisition unit configured to acquire error information relating to at least one of the phase difference and amplitude difference of the reception signals corresponding to the wiring length difference between the virtual antennas, based on a comparison result of the reception signals between the virtual antennas in at least (Ns+Nr−1) belonging sets; and an estimation unit configured to estimate temperature information related to internal temperature of the housing unit according to the error information.

According to these aspects, temperature information is estimated from error information corresponding to the wiring length difference of the virtual antennas. The error information corresponding to the wiring length difference is derived from wiring length changes due to linear expansion according to temperature, and the wiring length change due to linear expansion is linear with respect to temperature. Therefore, even at low and high temperatures, sensitivity degradation in temperature detection can be suppressed. Accordingly, temperature detection with suppressed sensitivity degradation becomes possible.

Hereinafter, embodiments of the present disclosure will be described with reference to the drawings. In each embodiment, corresponding components may be denoted by the same reference numerals, and redundant explanations may be omitted. Further, when only a part of a configuration is described in each embodiment, other parts of the configuration may be applied from the configuration described in other preceding embodiments. Furthermore, unless there is a particular hindrance to such combinations, not only the combinations of configurations explicitly described in each embodiment, but also partial combinations of configurations from multiple embodiments may be implemented, even if not explicitly stated.

### First Embodiment

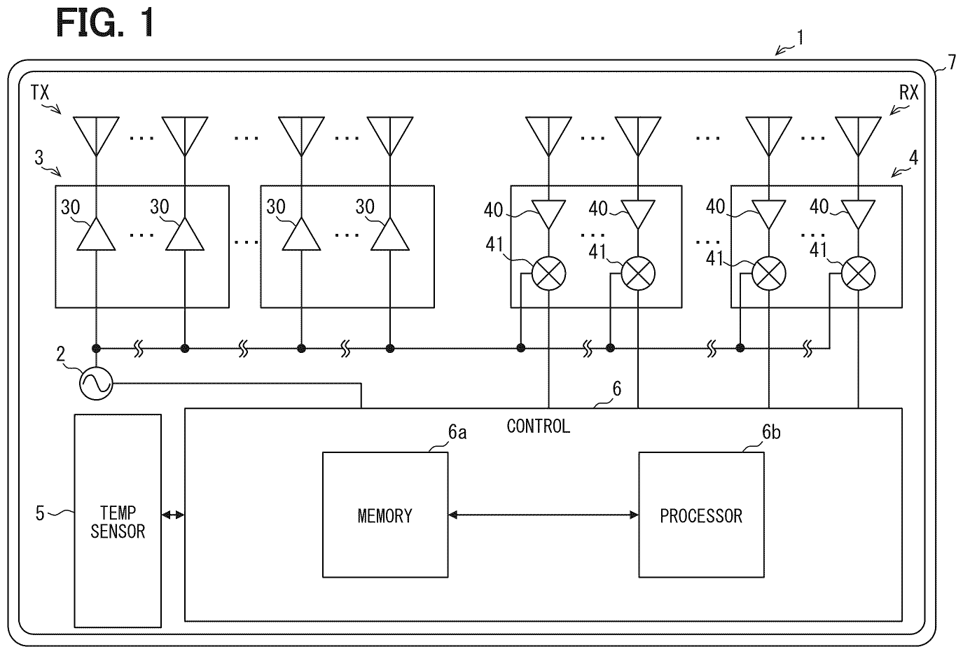

The first embodiment of the present disclosure will be described with reference to FIGS. 1 to 12. The radar device 1 is mounted, for example, on a vehicle or other moving object. The radar device 1 transmits a transmission signal, receives the transmission signal reflected by an object as a reception signal, and detects, as target information, the distance to the target (the object reflecting the transmission signal), the relative speed with respect to the target, the direction of the target, etc.

The target information output from the radar device 1 is input, for example, to an in-vehicle ECU (Electronic Control Unit) via an in-vehicle network such as CAN (Control Area Network (registered trademark)) or Ethernet (registered trademark). The in-vehicle ECU executes various processes for autonomous driving or advanced driver assistance of the vehicle based on the target information of each acquired target.

Examples of processing based on the target information include collision avoidance processing and warning processing. Collision avoidance processing is processing for controlling the vehicle to avoid collision with a target by controlling the brake system, steering system, etc., based on the target information of each target. Warning processing is processing for warning the driver of the possibility of collision with a target based on the target information of each target.

As shown in the basic configuration of FIG. 1, the radar device 1 of the present embodiment includes an oscillator 2, a plurality of transmission circuits 3, a plurality of transmission antennas TX, a plurality of reception antennas RX, a plurality of reception circuits 4, a temperature sensor 5, a control unit 6, and a housing unit 7. The radar device 1 is a so-called MIMO (Multiple-Input-Multiple-Output) radar, which transmits transmission signals from a plurality of transmission antennas TX and thereby virtually increases the number of reception antennas RX beyond the actual number.

The oscillator 2 acquires a control signal from the control unit 6 and generates a modulated signal modulated in accordance with the control signal. The modulated signal is, for example, a so-called chirp signal whose frequency changes over time. The modulated signal is distributed and output to each channel of the transmission circuits 3 and the reception circuits 4. Hereinafter, the modulated signal output from the oscillator 2 to the transmission circuits 3 is referred to as the transmission signal. The modulated signal output from the oscillator 2 to the reception circuits 4 is referred to as the local signal.

The transmission circuits 3 and the reception circuits 4 are each mainly composed of semiconductor integrated circuit devices such as MMICs (Monolithic Microwave Integrated Circuits). The transmission circuits 3 are connected to the transmission antennas TX and output transmission signals to the transmission antennas TX. The number of transmission circuits 3 mounted in one radar device 1 is denoted as Ns, where Ns is an integer of 2 or more. Each transmission circuit 3 includes the same number of amplifiers 30 as the connected transmission antennas TX. The amplifier 30 amplifies the transmission signal output from the oscillator 2 and outputs it to the corresponding transmission antenna TX.

The transmission antenna TX converts the electrical signal supplied from the oscillator 2 as the transmission signal into a radio wave signal and transmits it to the outside. The transmission antenna TX is configured to include at least one antenna element. For example, the transmission antenna TX is a patch antenna having a plurality of antenna elements of planar shape. The antenna elements are arranged on the surface of a dielectric substrate opposite to the ground plate provided on one side, so as to face the ground plate. The plurality of antenna elements are, for example, connected in series by a feed line that supplies the electrical signal.

The reception antenna RX receives, as a reception signal, a radio wave signal including the transmission signal reflected by a target as a reflector in the external environment. The reception antenna RX is connected to a corresponding reception circuit 4. The arrangement of the transmission antennas TX and the reception antennas RX will be described later.

The reception antenna RX converts the reception signal, which is a radio wave signal, into an electrical signal and outputs it to the corresponding reception circuit 4. The reception antenna RX is, for example, a patch antenna in which at least one antenna element is connected in series by a feed line, similar to the transmission antenna TX.

The reception circuit 4 is connected to the reception antenna RX and acquires the reception signal received by the reception antenna RX. The number of reception circuits 4 mounted in one radar device 1 is denoted as Nr, where Nr is an integer of 2 or more. The reception circuit 4 includes the same number of amplifiers 40 and signal mixing units 41 as the connected reception antennas RX.

The amplifier 40 amplifies the reception signal received by the reception antenna and outputs it to the signal mixing unit 41. The signal mixing unit 41 generates a beat signal in which the local signal from the oscillator 2 and the reception signal are mixed. The generated beat signal is an interference signal representing the frequency difference between the reception signal and the local signal. The beat signal, after high-frequency components outside the frequency difference between the reception signal and the local signal have been filtered out by a low-pass filter (not shown), is output to the control unit 6 as signal data related to the reception signal.

The temperature sensor 5 detects the internal temperature of the radar device 1. The temperature sensor 5 is provided inside the housing unit 7. The temperature sensor 5 includes, for example, a thermistor and outputs temperature information corresponding to the resistance value of the thermistor. The temperature sensor 5 detects the temperature information of each transmission circuit 3 and reception circuit 4 and outputs it to the control unit 6.

The housing unit 7 is a housing that accommodates the transmission antennas TX, reception antennas RX, oscillator 2, transmission circuits 3, reception circuits 4, temperature sensor 5, and control unit 6. For example, the housing unit 7 includes a radome that protects the antennas TX and RX while allowing transmission and reception signals to pass through, and a case body that is fixed to the radome and partitions and forms a housing space together with the radome to accommodate the above-mentioned components of the radar device 1.

The control unit 6 is a control section comprising at least one dedicated computer. The dedicated computer constituting the control unit 6 may be, for example, an ECU (Electronic Control Unit) specialized for controlling the radar device 1.

The dedicated computer constituting the control unit 6 includes at least one memory 6a and at least one processor 6b. The memory 6a is a non-transitory tangible storage medium, such as a semiconductor memory, magnetic medium, or optical medium, which non-transitorily stores programs and data readable by the computer. Here, storage may refer to accumulation in which data is retained even when the sensor system is powered off, or temporary storage in which data is erased when the sensor system is turned off.

The processor 6b may include at least one core selected from, for example, a CPU (Central Processing Unit), GPU (Graphics Processing Unit), RISC-CPU (Reduced Instruction Set Computer CPU), DFP (Data Flow Processor), and GSP (Graph Streaming Processor). Alternatively, the processor 6b may be at least one of a digital circuit or an analog circuit. The digital circuit may be at least one selected from, for example, ASIC (Application Specific Integrated Circuit), FPGA (Field Programmable Gate Array), SOC (System on a Chip), PGA (Programmable Gate Array), and CPLD (Complex Programmable Logic Device). Such digital circuits may also include a memory 6a storing programs.

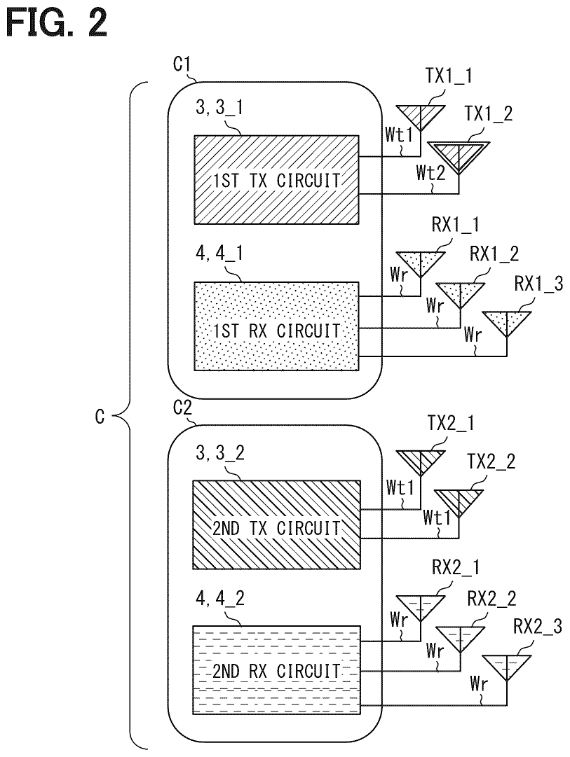

The control unit 6 executes angle measurement processing to calculate the angle of a reflector with respect to the radar device 1 by processing a plurality of beat signals output from the plurality of reception circuits 4. The radar device 1 secures relatively high angular resolution by virtually increasing the number of reception antennas RX beyond the actual number using the MIMO method. In addition, the control unit 6 secures relatively high angle measurement accuracy by executing compensation processing to compensate for phase difference and amplitude difference of signals occurring between different transmission circuits 3 and different reception circuits 4. For compensation processing, each transmission antenna TX and reception antenna RX is implemented in a prescribed arrangement. The arrangement of the transmission antennas TX and reception antennas RX will be described below with reference to specific examples shown in FIGS. 2 to 4.

By means of the plurality of transmission antennas TX and the plurality of reception antennas RX, for each transmission antenna TX, a plurality of virtual antennas V corresponding to the phase difference of the reception signals among the reception antennas RX are assumed. The virtual position of each virtual antenna V is defined by the relative position of the corresponding transmission antenna TX with respect to the other transmission antennas TX, and the relative position of the corresponding reception antenna RX with respect to the other reception antennas RX.

The transmission antennas TX and the reception antennas RX are arranged so that, among the collection of sets of virtual antennas V where the virtual positions overlap between groups of virtual antennas V assumed for each transmitting antenna TX, and the combinations of transmission circuit 3 and reception circuit 4 are different, the number of unique sets of virtual antennas V, for which the combination of transmission circuit 3 and reception circuit 4 does not overlap with any other set, is at least Ns+Nr−2. In other words, the transmission antennas TX and reception antennas RX are arranged so as to satisfy the following conditions. Specifically, among the groups of virtual antennas V assumed for each transmission antenna TX, there exist sets (pairs) of virtual antennas whose virtual positions overlap and whose combinations of transmission circuits 3 and reception circuits 4 are different. Within the collection of such sets of virtual antennas V, at least Ns+Nr−2 unique sets are included in the arrangement.

As an example, consider a radar device 1 equipped with four transmission antennas TX and six reception antennas RX. In this example, the number of transmission circuits 3 is Ns=2, and the number of reception circuits 4 is Nr=2. In this case, as shown in FIG. 2, the number of channels in one transmission circuit 3 is at least two. The number of channels in one reception circuit 4 is at least three. Hereinafter, one of the transmission circuits 3 is referred to as the first transmission circuit 3_1, and the other as the second transmission circuit 3_2. Similarly, one of the reception circuits 4 is referred to as the first reception circuit 4_1, and the other as the second reception circuit 4_2. In this embodiment, each circuit is mounted on a plurality of circuit chips C. Specifically, the first transmission circuit 3_1 and the first reception circuit 4_1 are mounted on the same first circuit chip C1. The second transmission circuit 3_2 and the second reception circuit 4_2 are mounted on the same second circuit chip C2.

Furthermore, in the radar device 1 of the present embodiment, at least one transmission antenna TX has a wiring length different from that of the other transmission antennas TX. In the example shown in FIG. 2, the wiring Wt2 of the transmission antenna TX1_2 connected to the first transmission circuit 3_1 is longer than the wiring Wt1 of the other transmission antennas TX. The wiring length of each wiring Wr of the reception antennas RX is substantially the same. Furthermore, the transmission antennas TX and reception antennas RX are arranged such that the wiring length difference among virtual antennas in a belonging set (also referred to as an associated set) described later reaches the allowable difference range.

Hereinafter, the four transmission antennas TX and six reception antennas RX may be distinguished by different reference numerals. Specifically, the two transmission antennas TX connected to the first transmission circuit 3_1 are referred to as transmission antennas TX1_1 and TX1_2, and the two transmission antennas TX connected to the second transmission circuit 3_2 are referred to as transmission antennas TX2_1 and TX2_2. The three reception antennas RX connected to the first reception circuit 4_1 are referred to as reception antennas RX1_1, RX1_2, and RX1_3, and the three reception antennas RX connected to the second reception circuit 4_2 are referred to as reception antennas RX2_1, RX2_2, and RX2_3.

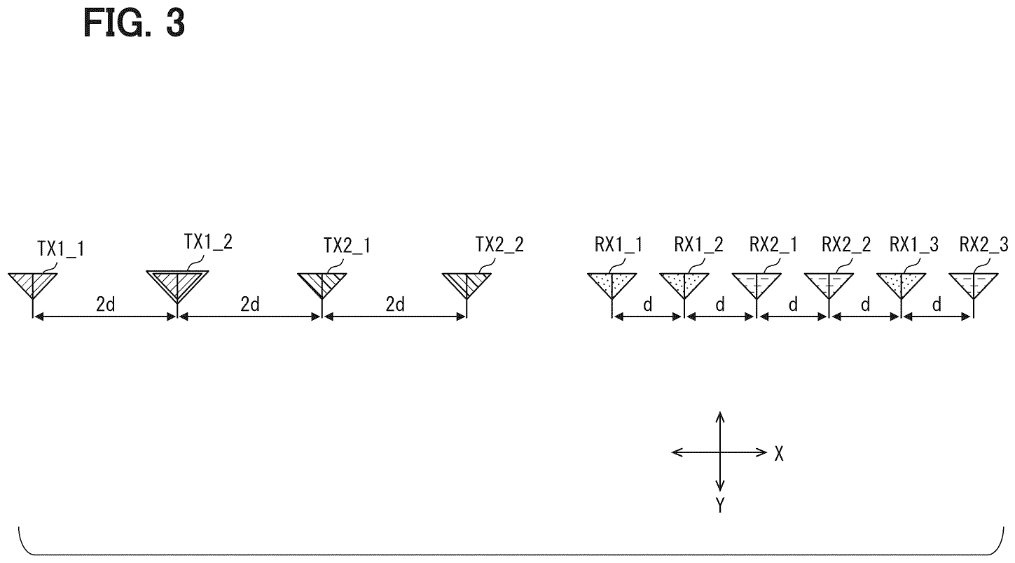

In the example shown in FIG. 3, the transmission antennas TX1_1, TX1_2, TX2_1, and TX2_2 are arranged at intervals of 2d in the X direction, which is the reference direction, from one side to the other in this order. Furthermore, the reception antennas RX1_1, RX1_2, RX2_1, RX2_2, RX2_3, and RX1_3 are arranged at intervals of d in the X direction from one side to the other in this order.

When antennas with different wiring lengths are present, the transmission antennas TX and reception antennas RX are arranged such that, among the collection of the sets of virtual antennas in which the virtual positions overlap among groups of virtual antennas assumed for each transmission antenna TX, and the combination of transmission circuit 3 and reception circuit 4 does not match, the number of unique sets, which are sets of virtual antennas where the combination of transmission circuit 3 and reception circuit 4 does not overlap with other sets, is at least (Ns+Nr−2), that is, two sets. In this embodiment, the transmission antennas TX and reception antennas RX are each arranged at equal intervals in a one-dimensional manner. Here, “one-dimensional arrangement” means that they are arranged along one reference direction.

For each of the transmission antennas TX1_1, TX1_2, TX2_1, and TX2_2, six virtual antennas V are assumed, corresponding to the number of reception antennas RX. Therefore, a total of 24 virtual antennas V are assumed.

Here, for the transmission antenna TX1_1, the plurality of virtual antennas V assumed are denoted, from one side to the other, as virtual antennas V1, V2, V3, V4, V5, and V6. For the transmission antenna TX1_2, the plurality of virtual antennas V assumed are denoted, from one side to the other, as virtual antennas V7, V8, V9, V10, V11, and V12. Furthermore, for the transmission antenna TX2_1, the group of virtual antennas V assumed are denoted, from one side to the other, as virtual antennas V13, V14, V15, V16, V17, and V18. For the transmission antenna TX2_2, the group of virtual antennas V assumed are denoted, from one side to the other, as virtual antennas V19, V20, V21, V22, V23, and V24.

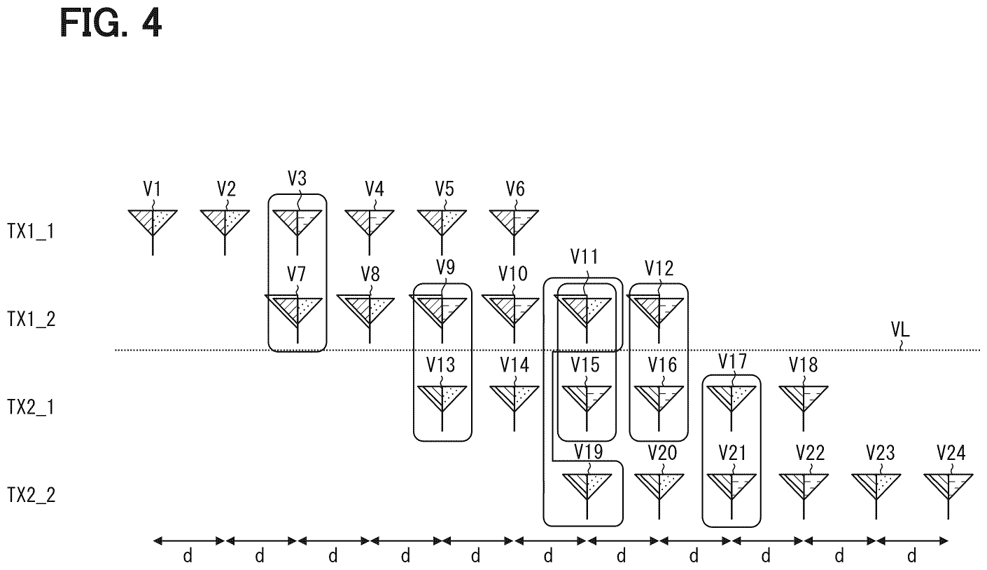

Since adjacent transmission antennas TX are arranged at intervals of 2d, the plurality of virtual antennas V assumed for a particular transmission antenna TX have virtual positions that are relatively shifted by 2d from the plurality of virtual antennas V assumed for the adjacent transmission antenna TX. Since the reception antennas RX are arranged at intervals of d, as shown in FIG. 4, there are 16 sets of virtual antennas V with overlapping virtual positions. Note that, for clarity in FIG. 4 and similar figures, the virtual positions of the plurality of virtual antennas V for each transmission antenna TX are depicted offset in the vertical direction of the page. In reality, the plurality of virtual antennas V are assumed to have their respective virtual positions on a virtual line VL extending in the reference direction (X direction). That is, in FIG. 4, virtual antennas V with the same left-right position on the page form a set of virtual antennas V with overlapping virtual positions. Hereinafter, specific sets of virtual antennas V with overlapping virtual positions are denoted as (Vn, Vm) using the reference numerals assigned to each individual virtual antenna V (where n and m are natural numbers).

Specifically, the following sets form sets of virtual antennas V with overlapping virtual positions: (V3, V7), (V4, V8), (V5, V9), (V5, V13), (V6, V10), (V6, V14), (V9, V13), (V10, V14), (V11, V15), (V11, V19), (V12, V16), (V12, V20), (V15, V16), (V16, V20), (V17, V21), and (V18, V22).

Among the above sets, the group of virtual antennas V in which the combination of transmission circuit 3 and reception circuit 4 does not match between the virtual antennas V in the set includes 14 sets, excluding (V6, V10) and (V18, V22). Among this group of virtual antennas V, the number of sets in which the combination of transmission circuit 3 and reception circuit 4 does not overlap with other sets is six, thereby satisfying the condition of at least (Ns+Nr−2) sets. An example of these six sets includes (V3, V7), (V9, V13), (V11, V15), (V11, V19), (V12, V16), and (V17, V21).

Furthermore, the transmission antennas TX and reception antennas RX are arranged such that at least one set of different wiring length sets, which are sets of virtual antennas V with overlapping virtual positions and non-matching wiring lengths, is included. The transmission antennas TX and reception antennas RX are also arranged such that the total number of belonging sets, which are sets of virtual antennas V belonging to at least one of the unique set and the different wiring length set described above, is at least (Ns+Nr−1).

In the example of the six sets described above, different wiring length sets are included. Specifically, among these six sets, five sets except for (V17, V21) are different wiring length sets, thereby satisfying the condition of at least one set. Accordingly, the total number of belonging sets is six, satisfying the condition of at least (Ns+Nr−1) sets.

Note that, as long as the combination of transmission circuit 3 and reception circuit 4 does not overlap with other sets, sets of virtual antennas V assumed for compensation processing may be other than those described above. For example, (V4, V8) and (V5, V9) overlap in the combination of transmission circuit 3 and reception circuit 4 with (V3, V7), but not with other sets. Therefore, assuming (V4, V8) or (V5, V9) as one of the six sets is equivalent to assuming (V3, V7).

Furthermore, if the control unit 6 secures at least (Ns+Nr−2) sets of virtual antennas V in which the combination of transmission circuit 3 and reception circuit 4 does not overlap with other sets, sets that overlap in the combination of transmission circuit 3 and reception circuit 4 with other sets may additionally be used for compensation processing.

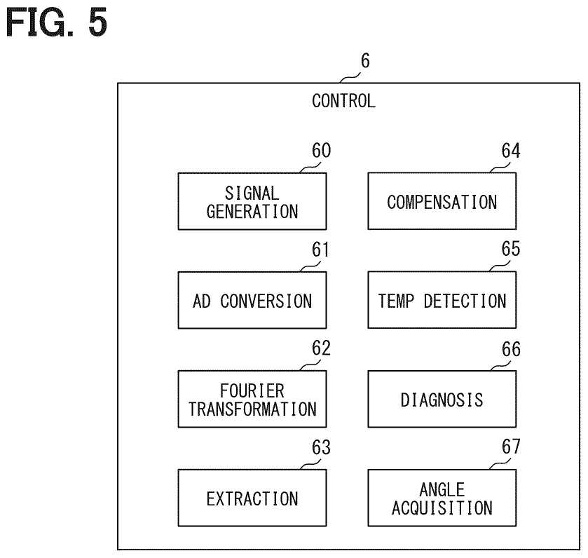

For the control of the radar device 1, including the above compensation processing, the processor 6b executes a plurality of instructions included in a control program stored in the memory 6a. As a result, the control unit 6 constructs functional units for controlling the radar device 1. Specifically, as shown in FIG. 5, the control unit 6 constructs, as functional units, a signal generation unit 60, an AD conversion unit 61, a Fourier transform unit 62, an extraction unit 63, a compensation unit 64, a temperature detection unit 65, a diagnosis unit 66, and an angle acquisition unit 67.

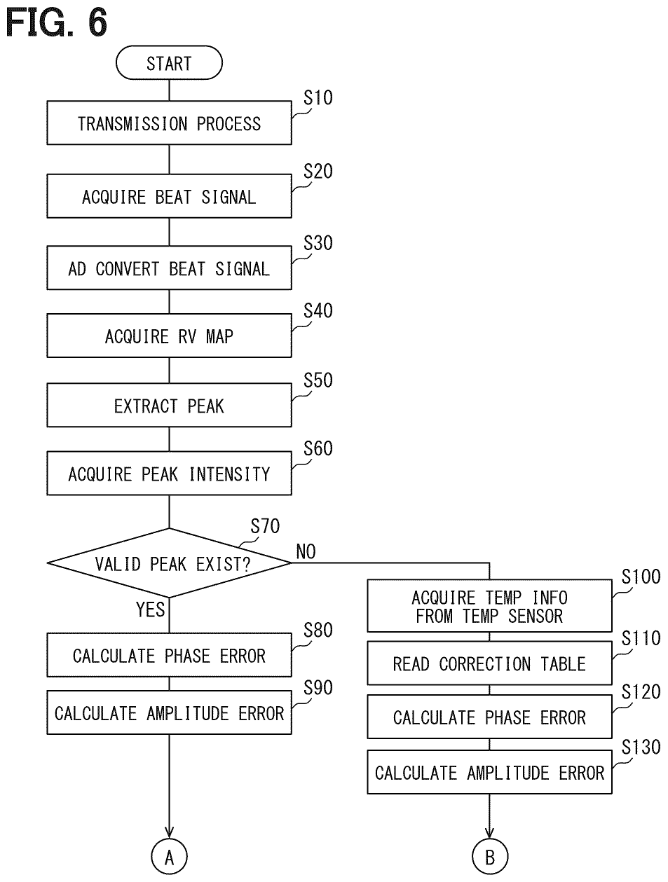

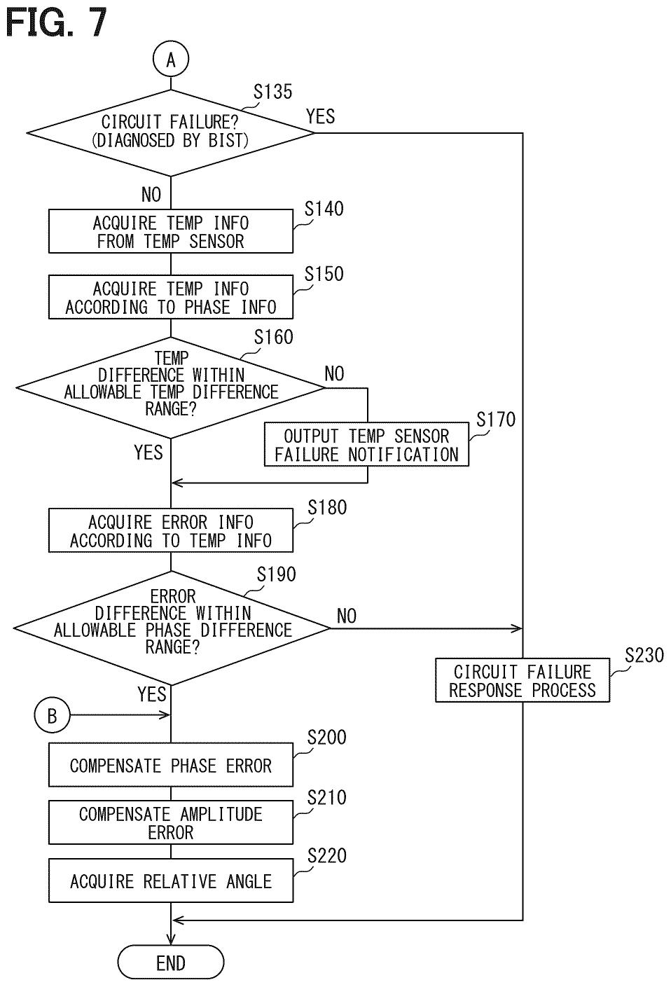

By means of these functions of the processor 6b, the radar control method by which the control unit 6 controls the radar device 1 is executed according to the control flow shown in FIG. 6 and FIG. 7. This control flow is repeatedly executed while the vehicle is activated. In this control flow, each “S” denotes a plurality of steps executed by a plurality of instructions included in the control program.

First, in S10, the signal generation unit 60 causes the oscillator 2 to output a transmission signal. Next, in S20, the AD conversion unit 61 acquires, from the reception circuit 4, a beat signal corresponding to the reception signal received by the reception antenna RX, which is the transmission signal transmitted from the transmission antenna TX and reflected by a target. In S30, the AD conversion unit 61 converts the beat signal into a digital signal by performing A/D conversion processing that samples the beat signal at predetermined time intervals. Next, in S40, the Fourier transform unit 62 performs FFT (Fast Fourier Transform) processing for each chirp of the A/D-converted beat signal. As a result, the Fourier transform unit 62 acquires, for each chirp, a frequency spectrum (distance spectrum) that exhibits a peak at the frequency position corresponding to the distance to the target. The distance spectrum is data indicating the signal intensity for each distance bin according to the distance resolution.

Then, the Fourier transform unit 62 performs FFT processing on the distance spectrum. That is, the Fourier transform unit 62 performs a second FFT processing on the waveform in which the phase at each distance bin obtained by the first FFT processing for a plurality of chirps is arranged in time series. As a result, a frequency spectrum (velocity spectrum) exhibiting a peak at the position corresponding to the relative velocity with the target is obtained for each velocity bin. By means of the above two-dimensional FFT, the Fourier transform unit 62 acquires two-dimensional information (RV map) exhibiting a peak at the position corresponding to the distance to the target and the relative velocity of the target.

Next, in S50, the extraction unit 63 extracts peaks from the RV map. In S60, the extraction unit 63 acquires the intensity of the extracted peaks. Then, in S70, the extraction unit 63 determines whether the extracted peaks are valid. For example, the extraction unit 63 determines that a peak is valid if its intensity is within the allowable intensity range. Here, the allowable intensity range is a range in which the intensity is equal to or greater than a predetermined threshold value. If it is determined that a valid peak exists, the flow proceeds to S80.

In S80, the compensation unit 64 acquires the phase error between transmission circuits 3, between reception circuits 4, and according to the wiring length difference of the virtual antennas V, based on the phase of valid peaks in each virtual channel. Here, the wiring length of a virtual antenna V means the total wiring length from the corresponding transmission antenna TX to the transmission circuit 3 and from the corresponding reception antenna RX to the reception circuit 4. Since only wiring Wt2 is longer than wiring Wt1, and all wiring Wr of the reception antennas RX are substantially equal in length, the wiring length of the virtual antennas V assumed for the transmission antenna TX1_2 is longer than that of the virtual antennas V assumed for the other transmission antennas TX.

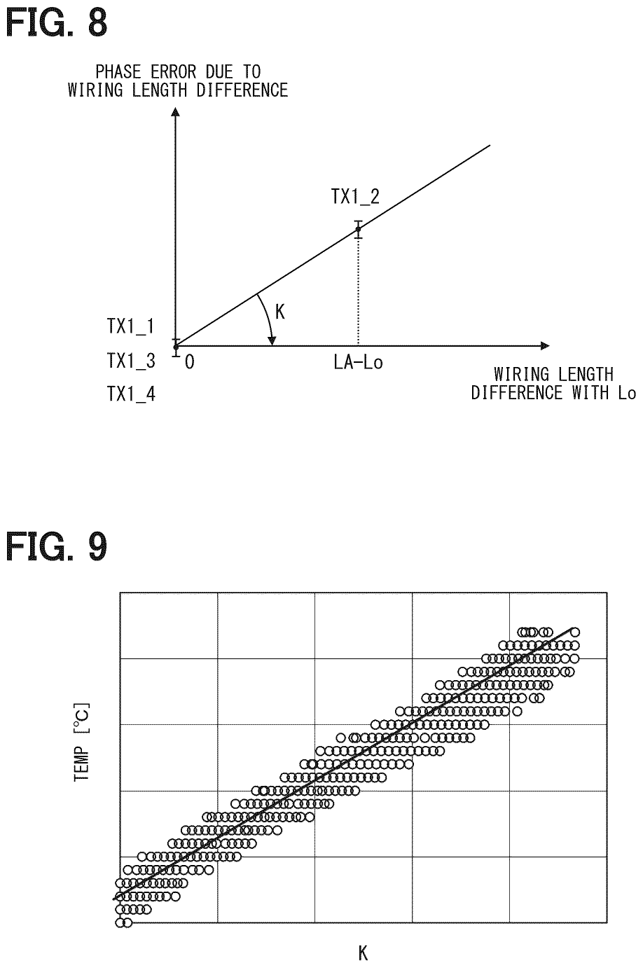

Generally, as shown in FIG. 8, the phase error due to the wiring length difference for each virtual antenna V increases linearly according to the wiring length difference with respect to the reference wiring length Lo (for example, the shortest wiring length). That is, the phase error with respect to the wiring length difference is a value obtained by multiplying the wiring length difference by parameter K. Therefore, as shown in FIG. 8, parameter K corresponds to the slope of the graph of phase error versus wiring length difference. That is, if the wiring length of the virtual antenna V assumed for the transmission antenna TX1_2 is LA, parameter K can be calculated from the wiring length difference LA-Lo. In this case, the reference wiring length Lo is the wiring length at room temperature of the virtual antennas V assumed for transmission antennas TX other than TX1_2.

The parameter K is a parameter corresponding to the value obtained by multiplying the linear expansion coefficient of the wiring by the temperature of the wiring. Since the linear expansion coefficient of an object does not depend on temperature, parameter K is a temperature parameter that varies according to temperature. As shown in FIG. 9, parameter K increases linearly as the temperature increases.

In the phase compensation processing, the compensation unit 64 defines a linear equation for each of at least (Ns+Nr−1) belonging sets of virtual antennas V, based on the phase difference of the peaks in the beat signals. In this linear equation, the relative phase error between transmission circuits 3, the relative phase error between reception circuits 4, and the relative phase error corresponding to the wiring length difference are defined as unknowns. The compensation unit 64 obtains the solution of this linear equation as the relative phase error. Since the beat signal is a signal related to the reception signal, the phase difference of the peaks in the beat signal is an example of the comparison result of the reception signals between virtual antennas V.

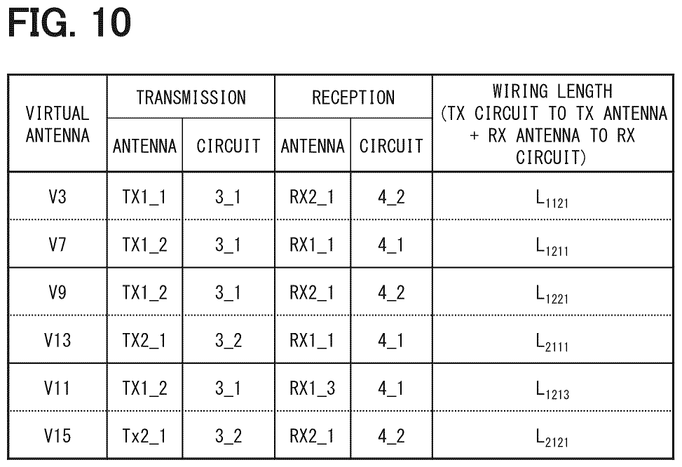

The acquisition of the relative phase error will be described in detail below. In the following explanation, the phase at the peak of the beat signal corresponding to virtual antenna Vn is denoted as θ_{Vn} (where n is a natural number). The wiring length difference in the virtual antenna V assumed for the combination of transmission antenna TXa_b and reception antenna RXi_j is denoted as L_{abij} (where a, b, i, and j are natural numbers). For simplicity in the following explanation, as shown in FIG. 10, three sets—(V3, V7), (V9, V13), and (V11, V15)—are used as the belonging sets. Let the phase error due to the wiring length difference L_{abij} be e_{abij}. In the example shown in FIG. 10, the phase difference of the peaks θ_{V3}-θ_{V7} for (V3, V7) can be defined by equation (1), the phase difference θ_{V9}-θ_{V13} for (V9, V13) by equation (2), and the phase difference θ_{V11}-θ_{V15} for (V11, V15) by equation (3).

$$\begin{matrix}( Equation 1 ) & \\ {θ}_{V 3} - {θ}_{V 7} = ( {Θ}_{a} + {e}_{tx 1} + {e}_{rx 2} + {e}_{1121} ) - ( {Θ}_{a} + {e}_{tx 1} + {e}_{rx 1} + {e}_{1211} ) & ( 1 )\end{matrix}$$

$$\begin{matrix}( Equation 2 ) & \\ {θ}_{V 9} - {θ}_{V 13} = ( {Θ}_{b} + {e}_{tx 1} + {e}_{rx 2} + {e}_{1221} ) - ( {Θ}_{b} + {e}_{tx 2} + {e}_{rx 1} + {e}_{2111} ) & ( 2 )\end{matrix}$$

$$\begin{matrix}( Equation 3 ) & \\ {θ}_{V 11} - {θ}_{V 15} = ( {Θ}_{c} + {e}_{tx 1} + {e}_{rx 1} + {e}_{1213} ) - ( {Θ}_{c} + {e}_{tx 2} + {e}_{rx 2} + {e}_{2121} ) & ( 3 )\end{matrix}$$

In the above equations, Θₐ, Θ_{b}, and θ_{c} are phase errors caused by the target, respectively. eₜₓ₁ is the phase error of the signal generated in the first transmission circuit 3_1, and eₜₓ₂ is the phase error of the signal generated in the second transmission circuit 3_2. eᵣₓ₁ is the phase error of the signal generated in the first reception circuit 4_1, and eᵣₓ₂ is the phase error of the signal generated in the second reception circuit 4_2.

Here, in phase compensation, it is sufficient to consider the relative phase error between transmission circuits 3 and the relative phase error between reception circuits 4. Therefore, by considering the relative phase error of the second transmission circuit 3_2 with respect to the first transmission circuit 3_1, and the relative phase error of the second reception circuit 4_2 with respect to the first reception circuit 4_1, eₜₓ₁ and eᵣₓ₁ can be set to zero. Here, by substituting the phase error e_{abij} with L_{abij} K, the above equations (1) to (3) can be transformed into the following equations (4) to (6).

$$\begin{matrix}( Equation 4 ) & \\ {θ}_{V 3} - {θ}_{V 7} = {e}_{rx 2} + ( {L}_{1121} - {L}_{1211} ) \cdot K & ( 4 )\end{matrix}$$

$$\begin{matrix}( Equation 5 ) & \\ {θ}_{V 9} - {θ}_{V 13} = - {e}_{tx 2} + {e}_{rx 2} + ( {L}_{1221} - {L}_{2111} ) \cdot K & ( 5 )\end{matrix}$$

$$\begin{matrix}( Equation 6 ) & \\ {θ}_{V 11} - {θ}_{V 15} = - {e}_{tx 2} - {e}_{rx 2} + ( {L}_{1213} - {L}_{2121} ) \cdot K & ( 6 )\end{matrix}$$

When this is converted into matrix form, the phase differences of each set and the relative phase errors satisfy the relationship expressed by the following equation (7).

$$\begin{matrix}( Equation 7 ) & \\ ( \begin{matrix}{θ}_{V 3} - {θ}_{V 7} \\ {θ}_{V 9} - {θ}_{V 13} \\ {θ}_{V 11} - {θ}_{V 15}\end{matrix} ) = ( \begin{matrix}0 & 1 & {L}_{1121} - {L}_{1211} \\ - 1 & 1 & {L}_{1221} - {L}_{2111} \\ - 1 & - 1 & {L}_{1213} - {L}_{2121}\end{matrix} ) \cdot ( \begin{matrix}{e}_{tx 2} \\ {e}_{rx 2} \\ K\end{matrix} ) & ( 7 )\end{matrix}$$

Here, the term on the left side of equation (7) is the phase difference vector Y1 between overlapping virtual antennas V. The first term on the right side of equation (7) is the coefficient matrix A1, and the second term is the phase error vector X1. The phase difference vector Y1 in equation (7) can be calculated from the peak phase of each beat signal. The coefficient matrix A1 is a constant matrix determined by the combinations of transmission circuits 3, reception circuits 4, and wiring length differences for each group of virtual antennas V. Therefore, equation (7) can be solved as a system of simultaneous equations with eₜₓ₂, eᵣₓ₂, and K as unknowns. That is, the compensation unit 64 obtains eₜₓ₂, eᵣₓ₂, and K as the relative phase error of the second transmission circuit 3_2 with respect to the first transmission circuit 3_1, the relative phase error of the second reception circuit 4_2 with respect to the first reception circuit 4_1, and the relative phase error corresponding to the wiring length difference, respectively. The compensation unit 64 is an example of the “error acquisition unit,” and the relative phase error is an example of “error information.”

Next, in S90, the compensation unit 64 acquires the amplitude error between transmission circuits 3 and between reception circuits 4, and the amplitude error corresponding to the wiring length difference, based on the amplitude of valid peaks in each virtual antenna V.

In the amplitude compensation processing, the compensation unit 64, similarly to the phase compensation processing, defines a linear equation for each of at least (Ns+Nr−1) belonging sets of virtual antennas V, based on the amplitude difference of the peaks in the beat signals, with the amplitude errors between transmission circuits 3 and between reception circuits 4 as unknowns. The compensation unit 64 obtains the solution of this linear equation as the relative amplitude error. The amplitude difference of the peaks in the beat signals is an example of the comparison result of the reception signals between virtual antennas V.

The amplitude error due to the wiring length difference with respect to the reference wiring length Lo increases linearly according to the wiring length difference, similar to the phase error. The amount of increase in amplitude error according to the wiring length difference varies with temperature. That is, the amplitude error due to the wiring length difference is a value obtained by multiplying the wiring length difference by parameter α.

In the following explanation, the same sets of virtual antennas V as in the above phase compensation processing are used for amplitude compensation processing. In the following explanation, the amplitude at the peak of the beat signal corresponding to virtual antenna Vn is denoted as A_{Vn} (where n is a natural number). Let the amplitude error due to the wiring length difference L_{abij} be G_{abij}. Then, the amplitude difference of the peaks A_{V3}-A_{V7} for (V3, V7) can be defined by equation (8), the amplitude difference A_{V9}-A_{V13} for (V9, V13) by equation (9), and the amplitude difference A_{V11}-A_{V15} for (V11, V15) by equation (10).

$$\begin{matrix}( Equation 8 ) & \\ {A}_{V 3} - {A}_{V 7} = ( {G}_{a} + {G}_{tx 1} + {G}_{rx 2} + {G}_{1121} ) - ( {G}_{a} + {G}_{tx 1} + {G}_{rx 1} + {G}_{1211} ) & ( 8 )\end{matrix}$$

$$\begin{matrix}( Equation 9 ) & \\ {A}_{V 9} - {A}_{V 13} = ( {G}_{b} + {G}_{tx 1} + {G}_{rx 2} + {G}_{1221} ) - ( {G}_{b} + {G}_{tx 2} + {G}_{rx 1} + {G}_{2111} ) & ( 9 )\end{matrix}$$

$$\begin{matrix}( Equation 10 ) & \\ {A}_{V 11} - {A}_{V 15} = ( {G}_{c} + {G}_{tx 1} + {G}_{rx 1} + {G}_{1213} ) - ( {G}_{c} + {G}_{tx 2} + {G}_{rx 2} + {G}_{2121} ) & ( 10 )\end{matrix}$$

Here, by substituting the amplitude error G_{abij} with L_{abij}·α, the above equations (8) to (10) can be transformed into the following equations (11) to (13).

$$\begin{matrix}( Equation 11 ) & \\ {A}_{V 3} - {A}_{V 7} = {G}_{rx 2} + ( {L}_{1121} - {L}_{1211} ) \cdot α & ( 11 )\end{matrix}$$

$$\begin{matrix}( Equation 12 ) & \\ {A}_{V 9} - {A}_{V 13} = - {G}_{tx 2} + {G}_{rx 2} + ( {L}_{1221} - {L}_{2111} ) \cdot α & ( 12 )\end{matrix}$$

$$\begin{matrix}( Equation 13 ) & \\ {A}_{V 11} - {A}_{V 15} = - {G}_{tx 2} - {G}_{rx 2} + ( {L}_{1213} - {L}_{2121} ) \cdot α & ( 13 )\end{matrix}$$

Here, when equations (11) to (13) are converted into matrix form, the amplitude differences of each set and the relative amplitude errors satisfy the relationship expressed by the following equation (14).

$$\begin{matrix}( Equation 14 ) & \\ ( \begin{matrix}{A}_{V 3} - {A}_{V 7} \\ {A}_{V 9} - {A}_{V 13} \\ {A}_{V 11} - {A}_{V 15}\end{matrix} ) = ( \begin{matrix}0 & 1 & {L}_{1121} - {L}_{1211} \\ - 1 & 1 & {L}_{1222} - {L}_{2112} \\ - 1 & - 1 & {L}_{1213} - {L}_{2121}\end{matrix} ) \cdot ( \begin{matrix}{G}_{tx 2} \\ {G}_{rx 2} \\ α\end{matrix} ) & ( 14 )\end{matrix}$$

Here, the term on the left side of equation (14) is the amplitude difference vector Y2 between virtual antennas V that share overlapping elements. The first term on the right side of equation (14) is the coefficient matrix A2, and the second term is the amplitude error vector X2. The amplitude difference vector Y2 can be calculated from the amplitude at the peak of each beat signal. The coefficient matrix A2 is a constant matrix defined by the combination of transmission circuits 3, reception circuits 4, and wiring lengths for each set of virtual antennas V. That is, the compensation unit 64 obtains Gₜₓ₂, Gᵣₓ₂, and α as the relative amplitude error of the second transmission circuit 3_2 with respect to the first transmission circuit 3_1, the relative amplitude error of the second reception circuit 4_2 with respect to the first reception circuit 4_1, and the relative amplitude error due to wiring length, as the solution of equation (14). After the processing of S90, the flow proceeds to S135 in FIG. 7.

On the other hand, if it is determined in S70 that no valid peak exists, the flow proceeds to S100. In S100, the compensation unit 64 acquires the temperature of each transmission circuit 3 and each reception circuit 4 from the temperature sensor 5. Then, in S110, the compensation unit 64 reads a correction table for the phase error and amplitude error between transmission circuits 3 according to temperature from the memory 6a.

Next, in S120, the compensation unit 64 acquires the relative phase error between transmission circuits 3 and between reception circuits 4 by comparing the acquired temperature with the correction table. Then, in S130, the compensation unit 64 acquires the relative amplitude error between transmission circuits 3 and between reception circuits 4 by comparing the acquired temperature with the correction table. After the processing of S130, the flow proceeds to S200 in FIG. 7, which will be described later.

Here, in S135, which follows the processing of S90, the diagnosis unit 66 executes failure diagnosis for each of the transmission circuits 3 and reception circuits 4. In this step, the diagnosis unit 66 performs a process different from the failure diagnosis based on error differences described later, that is, a process that does not depend on the comparison result of the reception signals between virtual antennas V with overlapping virtual positions, to diagnose the presence or absence of failure. For example, the diagnosis unit 66 may diagnose the presence or absence of failure using a BIST (Built-in Self-Test) function pre-installed in the control unit 6. If the diagnosis unit 66 diagnoses a failure in any of the circuits 3 or 4, the flow proceeds to S230 described later. On the other hand, if the diagnosis unit 66 diagnoses no failure in all circuits 3 and 4, the flow proceeds to S140. In S140, the temperature detection unit 65 acquires temperature information from the temperature sensor 5. Hereinafter, the temperature information acquired by the temperature sensor 5 may be referred to as sensor temperature information. In this embodiment, since the temperature sensor 5 detects the representative temperature of the circuits 3 and 4, the sensor temperature information is a temperature relatively close to the actual temperature of the circuits 3 and 4.

Further, in S150, the temperature detection unit 65 acquires temperature information based on phase information. Specifically, in S150, the temperature detection unit 65 detects temperature information based on the parameter K calculated in S80. As described above, parameter K is a parameter that varies according to temperature. That is, the temperature detection unit 65 can acquire temperature information from the correspondence between the value of parameter K and temperature, as shown in FIG. 9. This correspondence is stored in advance, for example, in a storage medium such as the memory 6a. The correspondence may be stored in the form of a function or a table, for example. Hereinafter, temperature information based on phase information may be referred to as phase temperature information. The temperature detection unit 65 is an example of the “estimation unit.”

Note that, since the phase temperature information is related to the temperature of the wiring, it is a temperature relatively close to the actual temperature of the wiring. That is, the sensor temperature information and the phase temperature information are basically different due to the difference in the temperature detection location. In this embodiment, the phase temperature information is generally lower than the sensor temperature information. For example, if the external temperature of the radar device 1 is equivalent to room temperature and the sensor temperature information from a normal temperature sensor 5 is about 60° C., the phase temperature information may be a lower temperature, for example, about 40° C. That is, if the temperature sensor 5 is normal, the temperature difference between the sensor temperature information and the phase temperature information will fall within a predetermined range.

Therefore, in S160, which follows S150, as a failure determination process for the temperature sensor 5, the diagnosis unit 66 determines whether the temperature difference between the sensor temperature information and the phase temperature information is within the allowable temperature difference range. Here, the allowable temperature difference range is the range of temperature differences defined as normal operation of the temperature sensor 5, and the allowable temperature difference range is defined as the range in which the temperature difference is less than or equal to the upper threshold value or less than the upper threshold value, and greater than or equal to the lower threshold value or greater than the lower threshold value.

If it is determined in S160 that the temperature difference is not within the allowable temperature difference range, that is, it is outside the allowable temperature difference range, the flow proceeds to S170. In S170, the diagnosis unit 66 outputs a failure notification of the temperature sensor 5 to the outside of the radar device 1. For example, the diagnosis unit 66 may output the failure notification to another ECU mounted in the vehicle. Alternatively, the diagnosis unit 66 may output the failure notification to an external center outside the vehicle. After the processing of S170, the flow proceeds to S180.

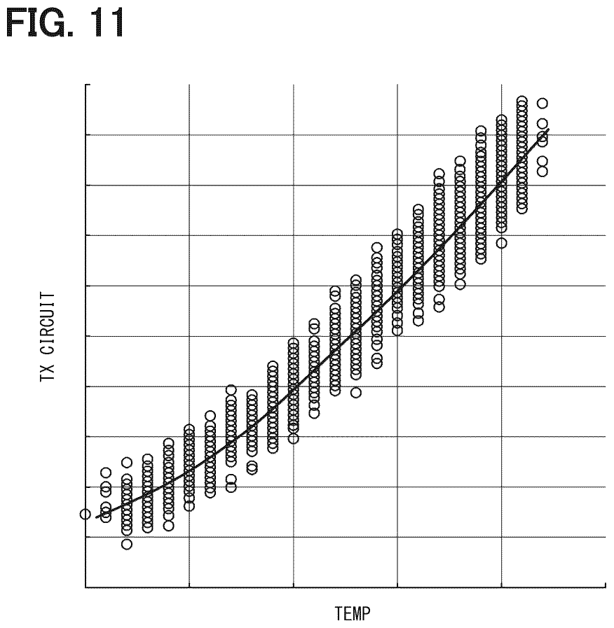

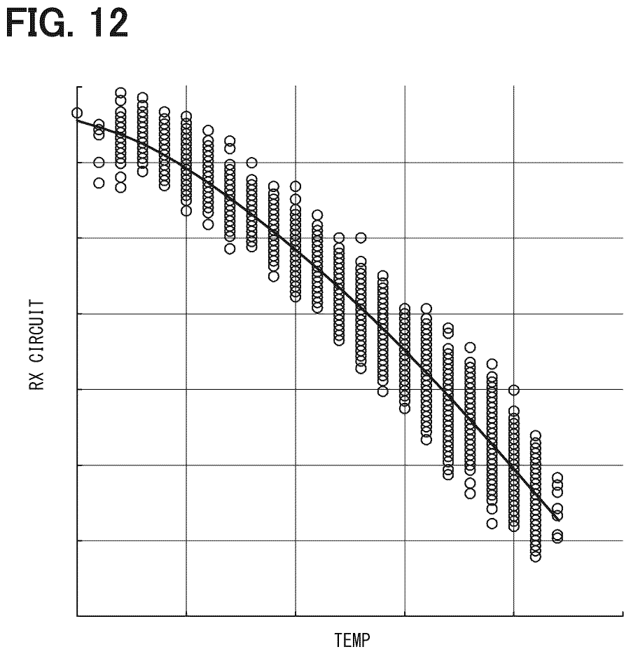

On the other hand, if it is determined in S160 that the temperature difference is within the allowable temperature difference range, the flow skips S170 and proceeds to S180. In S180, the diagnosis unit 66 acquires error information corresponding to the temperature information. Specifically, the diagnosis unit 66 acquires the relative phase error between transmission circuits 3 and between reception circuits 4 according to the temperature information. As shown in FIG. 11, there is a correlation between the temperature information and the relative phase error between transmission circuits 3. Similarly, as shown in FIG. 12, there is a correlation between the temperature information and the relative phase error between reception circuits 4. Therefore, the diagnosis unit 66 can acquire the relative phase error corresponding to the temperature information, independently of the comparison result of the reception signals. For example, the diagnosis unit 66 acquires the relative phase error corresponding to the temperature information based on these correlations, which are stored in advance in a storage medium such as the memory 6a in the form of relational expressions or tables. As the relational expressions of the correlations, for example, regression equations estimated from the correlation data, as shown in FIGS. 11 and 12, are stored.

As temperature information for calculating the relative phase error, either the sensor temperature information or the phase temperature information may be used. For example, when the temperature difference is within the allowable temperature difference range, that is, when the temperature sensor 5 is operating normally, the diagnosis unit 66 may use the sensor temperature information. When the temperature difference is outside the allowable temperature difference range, that is, when the temperature sensor 5 is malfunctioning, the diagnosis unit 66 may use the phase temperature information. Alternatively, the diagnosis unit 66 may selectively use the temperature information according to other conditions.

Next, in S190, the diagnosis unit 66 determines whether the phase error difference, which is the difference between the relative phase error according to the temperature information acquired in S180 and the relative phase error based on the reception result acquired in S80, is within the allowable error difference range. The diagnosis unit 66 determines whether both the phase error difference between transmission circuits 3 and the phase error difference between reception circuits 4 are within the allowable error difference range. The allowable error difference range is a range in which the phase error difference is less than or equal to, or less than a predetermined threshold value. The allowable error difference range for transmission circuits 3 and for reception circuits 4 may be the same or different.

If it is determined that the phase error difference is within the allowable error difference range, the flow proceeds to S200. In S200, the compensation unit 64 compensates for the phase error between transmission circuits 3 and between reception circuits 4. For example, the compensation unit 64 stores the acquired relative phase error in the memory 6a as compensation data for use in subsequent relative angle acquisition. Furthermore, in S210, the compensation unit 64 compensates for the relative amplitude error between transmission circuits 3 and between reception circuits 4 by storing it in the memory 6a as compensation data.

Then, in S220, the angle acquisition unit 67 acquires the relative angle of the target. Specifically, the angle acquisition unit 67 performs FFT processing on multiple peaks extracted from the beat signals based on the reception signals of each compensated virtual antenna V, thereby acquiring the phase difference between virtual antennas V. Since the phase difference between virtual antennas V is related to the relative angle of the target, the angle acquisition unit 67 converts the acquired phase difference into a relative angle to obtain the relative angle. At this time, the angle acquisition unit 67 uses the compensation data to compensate for the phase difference between transmission circuits 3 and between reception circuits 4 when acquiring the relative angle.

On the other hand, if a failure is diagnosed in S135, or if it is determined in S180 that the phase error difference is outside the allowable error difference range, the flow proceeds to S230. In S230, the diagnosis unit 66 executes circuit failure handling processing for circuits 3 or 4 in which the phase error difference is outside the allowable error difference range. In the circuit failure handling processing, the diagnosis unit 66, for example, outputs a failure notification for circuits 3 or 4 to the outside of the radar device 1. The diagnosis unit 66 may output the failure notification to another ECU mounted in the vehicle or to an external center outside the vehicle.

According to this first embodiment, temperature information is estimated from error information corresponding to the wiring length difference of the virtual antennas V. The error information corresponding to the wiring length difference is derived from wiring length changes due to linear expansion according to temperature. However, the wiring length change due to linear expansion is linear with respect to temperature. Therefore, even at low or high temperatures where the sensitivity of the thermistor may decrease, the decrease in sensitivity of temperature detection can be suppressed. Accordingly, the radar device 1 can perform temperature detection with suppressed sensitivity degradation.

### Second Embodiment

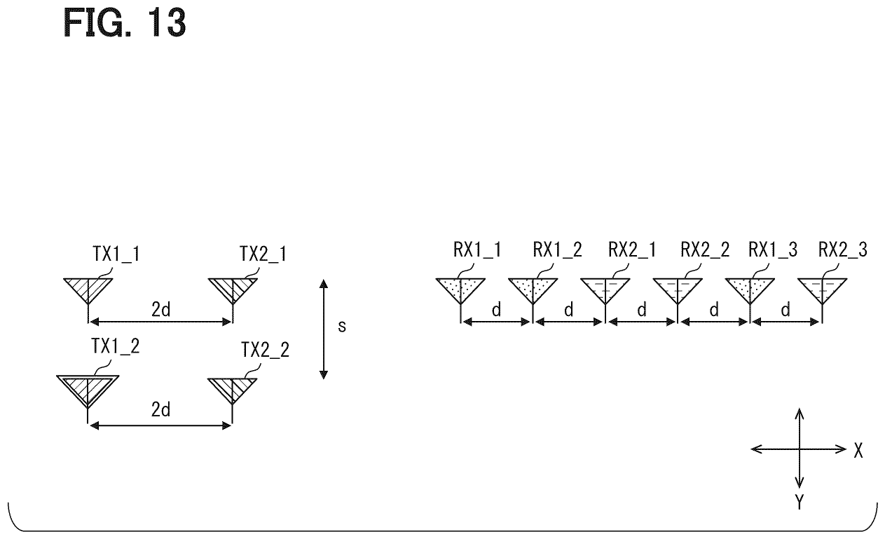

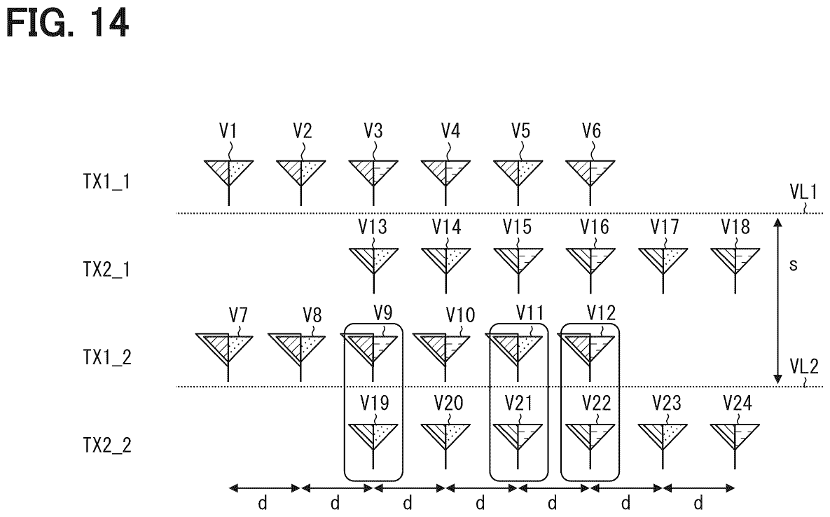

As shown in FIGS. 13 and 14, the second embodiment is a modification of the first embodiment. In the second embodiment, the transmission antennas TX are arranged in a two-dimensional configuration. That is, the transmission antennas TX are arranged at equal intervals in each of two reference directions.

In the second embodiment, the numbers of transmission antennas TX and reception antennas RX are the same as in the first embodiment. The numbers of transmission circuits 3 and reception circuits 4 are also the same as in the first embodiment.

In the example shown in FIG. 13, the transmission antennas TX1_1 and TX2_1 are arranged at intervals of 2d in the X direction from one side to the other in this order. Furthermore, the transmission antennas TX1_2 and TX1_2 are arranged at intervals of s in the Y direction, which is orthogonal to the X direction, from one side to the other in this order. The transmission antennas TX2_1 and TX2_2 are also arranged at intervals of s in the Y direction from one side to the other in this order. That is, the transmission antennas TX1_2 and TX2_2 are arranged in parallel to TX1_1 and TX2_1 with an interval of 2d.

The reception antennas RX1_1, RX1_2, RX2_1, RX2_2, RX2_3, and RX1_3 are arranged at intervals of d in the X direction from one side to the other in this order, as in the first embodiment. Since the numbers of antennas TX and RX are the same as in the first embodiment, a total of 24 virtual antennas V are assumed in the second embodiment as well, as shown in FIG. 14.

Since adjacent transmission antennas TX in the X direction are arranged at intervals of 2d, the row of virtual antennas V assumed for a particular transmission antenna TX is relatively shifted by 2d in virtual position from the row of virtual antennas V assumed for the adjacent transmission antenna TX in the X direction. Furthermore, since adjacent transmission antennas TX in the Y direction are arranged at intervals of s, the row of virtual antennas V assumed for a particular transmission antenna TX is relatively shifted by s in virtual position from the row of virtual antennas V assumed for the adjacent transmission antenna TX in the Y direction.

Note that, in FIG. 14 as in FIG. 4, the virtual positions of the plurality of virtual antennas V are depicted offset in the vertical direction of the page for clarity. In reality, the plurality of virtual antennas V assumed for the transmission antennas TX1_1 and TX2_1 are assumed to have their respective virtual positions on a virtual line VL1 extending in the X direction. The plurality of virtual antennas V assumed for the transmission antennas TX1_2 and TX2_2 are assumed to have their respective virtual positions on a virtual line VL2 extending in the X direction. The rows of virtual antennas V on virtual line VL1 and those on virtual line VL2 are separated by a distance s in the Y direction.

Therefore, as shown in FIG. 14, between the plurality of virtual antennas V assumed for the transmission antenna TX1_1 and those for TX2_1, sets of virtual antennas V with overlapping virtual positions can be assumed. Specifically, the sets of virtual antennas V with overlapping virtual positions are (V3, V13), (V4, V14), (V5, V15), and (V6, V16).

Similarly, between the plurality of virtual antennas V assumed for the transmission antenna TX1_2 and those for TX2_2, sets of virtual antennas V with overlapping virtual positions can be assumed. Specifically, (V9, V19), (V10, V20), (V11, V21), and (V12, V22) are sets of virtual antennas V with overlapping virtual positions.

All of the above sets constitute a collection in which the combination of transmission circuit 3 and reception circuit 4 does not overlap between the virtual antennas V in each set. Among this collection, the number of sets in which the combination of transmission circuit 3 and reception circuit 4 does not overlap with other sets is three, thereby satisfying the condition of at least (Ns+Nr−2) sets.

As an example of these three sets, (V3, V13), (V5, V15), and (V6, V16) can be assumed. Furthermore, as another example of three sets, (V9, V19), (V11, V21), and (V12, V22) can be assumed.

Note that (V4, V14), (V9, V19), and (V10, V20) overlap in the combination of transmission circuit 3 and reception circuit 4 with (V3, V13), but do not overlap with other sets. Therefore, assuming (V4, V14), (V9, V19), or (V10, V20) as one of the three sets is equivalent to assuming (V3, V13). Similarly, assuming (V11, V21) as one of the three sets is equivalent to assuming (V5, V15), and assuming (V12, V22) is equivalent to assuming (V6, V16).

Furthermore, among the above unique sets, the three sets (V9, V19), (V11, V21), and (V12, V22) are also different wiring length sets. Therefore, the condition of having at least one different wiring length set is satisfied.

Thus, there are at least three belonging sets that belong to at least one of the unique set and the different wiring length set, thereby satisfying the condition of at least (Ns+Nr−1) sets. As examples of the three belonging sets, (V9, V19), (V11, V21), and (V12, V22) can be assumed. Note that one or two of (V9, V19), (V11, V21), and (V12, V22) may be replaced with sets having the equivalent relationship described above.

### Third Embodiment

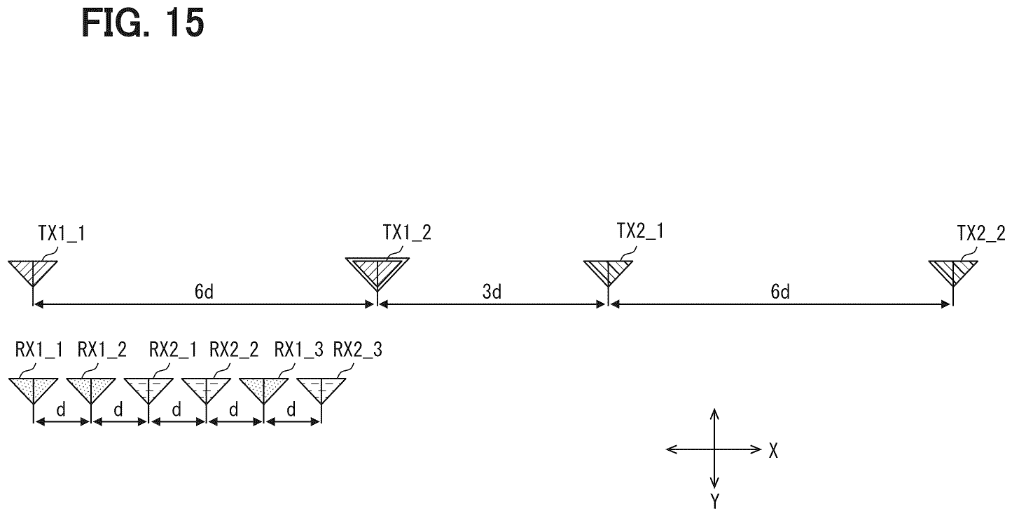

As shown in FIG. 15 to FIG. 17, the third embodiment is a modification of the first embodiment. In the radar device 1 of the third embodiment, the numbers of transmission antennas TX and reception antennas RX, and the numbers of transmission circuits 3 and reception circuits 4, are the same as in the first embodiment. Furthermore, the combinations of transmission antennas TX and transmission circuits 3, and reception antennas RX and reception circuits 4, are the same as those shown in FIG. 2.

In this embodiment, the transmission antennas TX are arranged at unequal intervals. In the example shown in FIG. 15, the transmission antennas TX1_1, TX1_2, TX2_1, and TX2_2 are arranged in the X direction, which is the reference direction, from one side to the other in this order. The transmission antennas TX1_1 and TX1_2 are arranged with an interval of 6d. The transmission antennas TX1_2 and TX2_1 are arranged with an interval of 3d. The transmission antennas TX2_1 and TX2_2 are arranged with an interval of 6d.

Furthermore, the reception antennas RX1_1, RX1_2, RX2_1, RX2_2, RX2_3, and RX1_3 are arranged at intervals of d in the reference direction from one side to the other in this order.

For each of the transmission antennas TX1_1, TX1_2, TX2_1, and TX2_2, six virtual antennas V are assumed, corresponding to the number of reception antennas RX. Therefore, the total number of assumed virtual antennas V is 24.

As in the first embodiment, for the transmission antenna TX1_1, the plurality of virtual antennas V assumed are denoted, from one side to the other, as virtual antennas V1, V2, V3, V4, V5, and V6. For the transmission antenna TX1_2, the plurality of virtual antennas V assumed are denoted, from one side to the other, as virtual antennas V7, V8, V9, V10, V11, and V12. For the group of virtual antennas V assumed for the transmission antenna TX2_1, they are denoted, from one side to the other, as virtual antennas V13, V14, V15, V16, V17, and V18. For the group of virtual antennas V assumed for the transmission antenna TX2_2, they are denoted, from one side to the other, as virtual antennas V19, V20, V21, V22, V23, and V24.

Since the transmission antennas TX1_1 and TX1_2 are arranged at intervals of 6d, the group of virtual antennas V assumed for TX1_1 are relatively shifted by 6d in virtual position from the group of virtual antennas V assumed for TX1_2. Since TX1_2 and TX2_1 are arranged at intervals of 3d, the group of virtual antennas V assumed for TX1_2 are relatively shifted by 3d in virtual position from the group of virtual antennas V assumed for TX2_1. Furthermore, since TX2_1 and TX2_2 are arranged at intervals of 6d, the group of virtual antennas V assumed for TX2_1 are relatively shifted by 6d in virtual position from the group of virtual antennas V assumed for TX2_2.

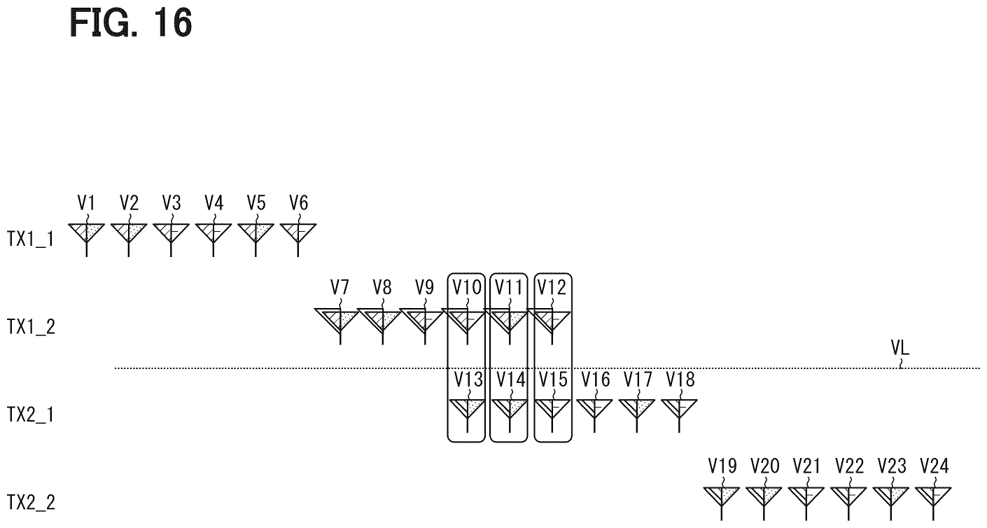

Therefore, with such an arrangement of antennas TX and RX, as shown in FIG. 16, there are three sets of virtual antennas V with overlapping virtual positions. The plurality of virtual antennas V are assumed to have their respective virtual positions on a virtual line VL extending in the reference direction (X direction). Specifically, (V10, V13), (V11, V14), and (V12, V15) are sets of virtual antennas V with overlapping virtual positions.

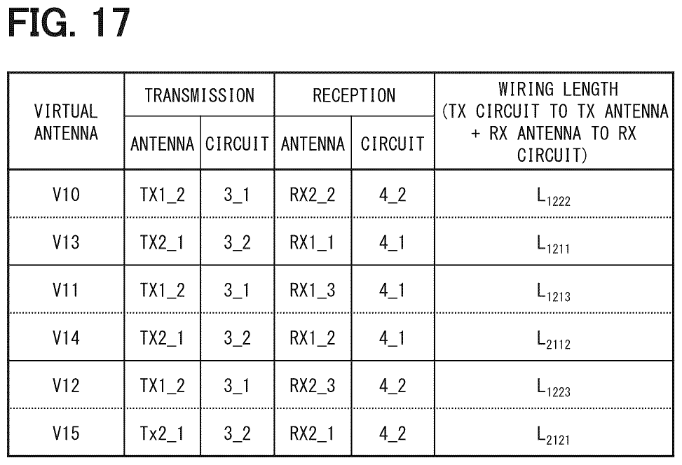

As shown in FIG. 16 and FIG. 17, these three sets constitute a collection in which the combination of transmission circuit 3 and reception circuit 4 does not match between the virtual antennas V in each set. Furthermore, these three sets are such that the combination of transmission circuit 3 and reception circuit 4 does not overlap among the sets. Therefore, in this antenna arrangement, the number of unique sets is three, satisfying the condition of at least (Ns+Nr−2) sets.

Furthermore, these three sets are all different wiring length sets. That is, the wiring lengths of virtual antennas V10, V11, and V12 are longer than those of virtual antennas V13, V14, and V15. Accordingly, in this antenna arrangement, the number of different wiring length sets is three, satisfying the condition of at least one set. Thus, in this antenna arrangement, the number of belonging sets is three, satisfying the condition of at least (Ns+Nr−1) sets.

### Fourth Embodiment

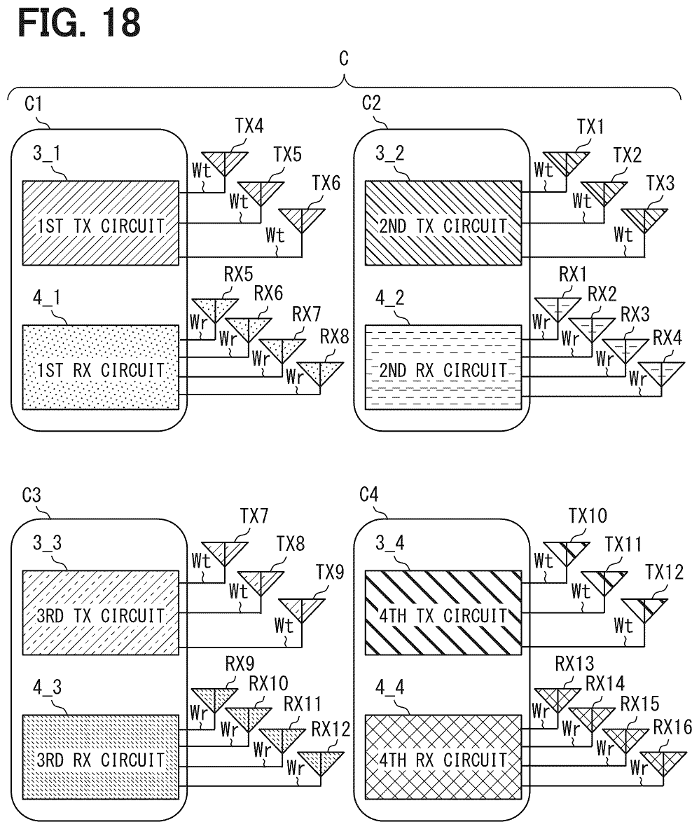

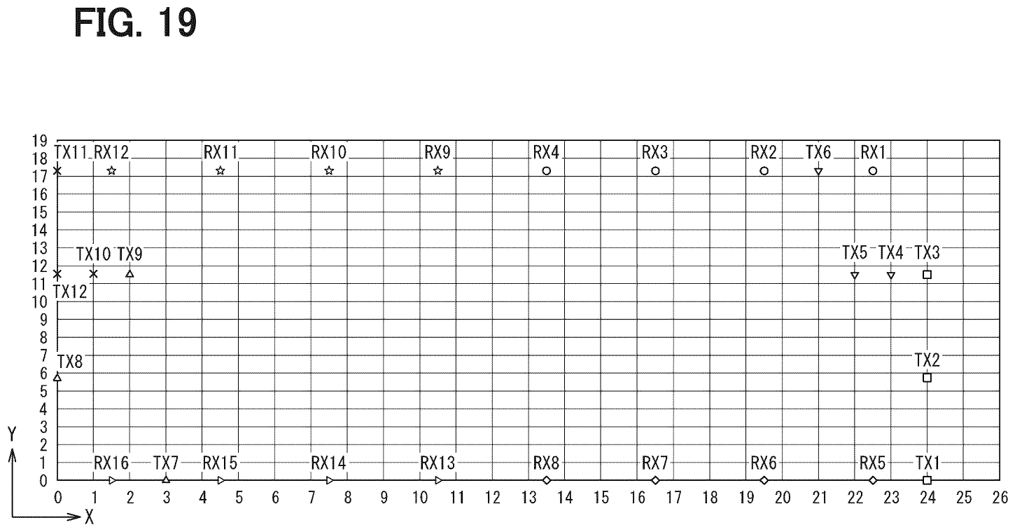

As shown in FIG. 18 to FIG. 21, the fourth embodiment is a modification of the first embodiment. In the fourth embodiment, the transmission antennas TX and reception antennas RX are arranged in a two-dimensional configuration, and the transmission antennas TX are arranged at unequal intervals.

As an example in this embodiment, a radar device 1 is assumed in which twelve transmission antennas TX and sixteen reception antennas RX are implemented. In this example, the number of transmission circuits 3 is Ns=4, and the number of reception circuits 4 is Nr=4. In this case, as shown in FIG. 18, the number of channels per transmission circuit 3 is at least three, and the number of channels per reception circuit 4 is at least four. Hereinafter, the four transmission circuits 3 may be distinguished as first transmission circuit 3_1, second transmission circuit 3_2, third transmission circuit 3_3, and fourth transmission circuit 3_4. Similarly, the four reception circuits 4 may be distinguished as first reception circuit 4_1, second reception circuit 4_2, third reception circuit 4_3, and fourth reception circuit 4_4.

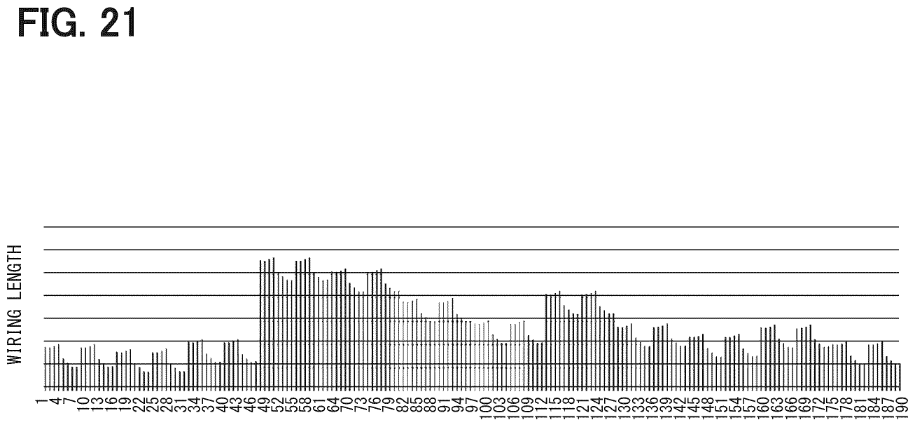

In this embodiment as well, each circuit is implemented on a plurality of circuit chips C. Specifically, the first transmission circuit 3_1 and the first reception circuit 4_1 are implemented on the same first circuit chip C1, and the second transmission circuit 3_2 and the second reception circuit 4_2 are implemented on the same second circuit chip C2. In addition, the third transmission circuit 3_3 and the third reception circuit 4_3 are implemented on the same third circuit chip C3, and the fourth transmission circuit 3_4 and the fourth reception circuit 4_4 are implemented on the same fourth circuit chip C4. The wiring length of each wiring Wt between the transmission antennas TX and the corresponding transmission circuit 3, and the wiring length of each wiring Wr between the reception antennas RX and the corresponding reception circuit 4, are defined such that the wiring length of each assumed virtual antenna V has the relative relationship shown in the graph of FIG. 21. That is, at least one of the wiring length from each transmission circuit 3 to each transmission antenna TX and the wiring length from each reception antenna RX to each reception circuit 4 is defined such that the wiring length of the corresponding virtual antenna V has the relative relationship shown in FIG. 17.

Hereinafter, the three transmission antennas TX connected to the first transmission circuit 3_1 may be referred to as transmission antennas TX4, TX5, and TX6, and the three transmission antennas TX connected to the second transmission circuit 3_2 may be referred to as transmission antennas TX1, TX2, and TX3. The three transmission antennas TX connected to the third transmission circuit 3_3 may be referred to as transmission antennas TX7, TX8, and TX9, and the three transmission antennas TX connected to the fourth transmission circuit 3_4 may be referred to as transmission antennas TX10, TX11, and TX12.

Similarly, the four reception antennas RX connected to the first reception circuit 4_1 may be referred to as reception antennas RX5, RX6, RX7, and RX8, and the four reception antennas RX connected to the second reception circuit 4_2 may be referred to as reception antennas RX1, RX2, RX3, and RX4. The four reception antennas RX connected to the third reception circuit 4_3 may be referred to as reception antennas RX9, RX10, RX11, and RX12, and the four reception antennas RX connected to the fourth reception circuit 4_4 may be referred to as reception antennas RX13, RX14, RX15, and RX16.

The above transmission antennas TX and reception antennas RX are arranged in a two-dimensional configuration. As shown in FIG. 19, four rows of multiple transmission antennas TX aligned in the X direction are arranged with separation in the Y direction. Of these four rows aligned in the X direction, the first, second, and fourth rows from the origin side each have two transmission antennas TX. Furthermore, in the third row from the origin side, there are six transmission antennas TX arranged in the X direction. Here, the interval of one scale in the X direction is d, and the interval of one scale in the Y direction is s. Transmission antennas TX12, TX10, and TX9 are arranged at equal intervals of d. Likewise, transmission antennas TX5, TX4, and TX3 are also arranged at equal intervals of d. On the other hand, the interval between transmission antenna TX9 and transmission antenna TX5 is 20d. That is, in this third row, the transmission antennas TX are arranged at unequal intervals in the X direction.

Furthermore, two rows of multiple reception antennas RX aligned in the X direction are arranged with separation in the Y direction. In each of these two rows aligned in the X direction, eight reception antennas RX are arranged. In each row, these reception antennas RX are arranged at equal intervals in the X direction. Of these two rows aligned in the X direction, the first row from the origin side is arranged to align in the Y direction with the first row of transmission antennas TX from the origin side, and the second row from the origin side is arranged to align in the Y direction with the fourth row of transmission antennas TX from the origin side.

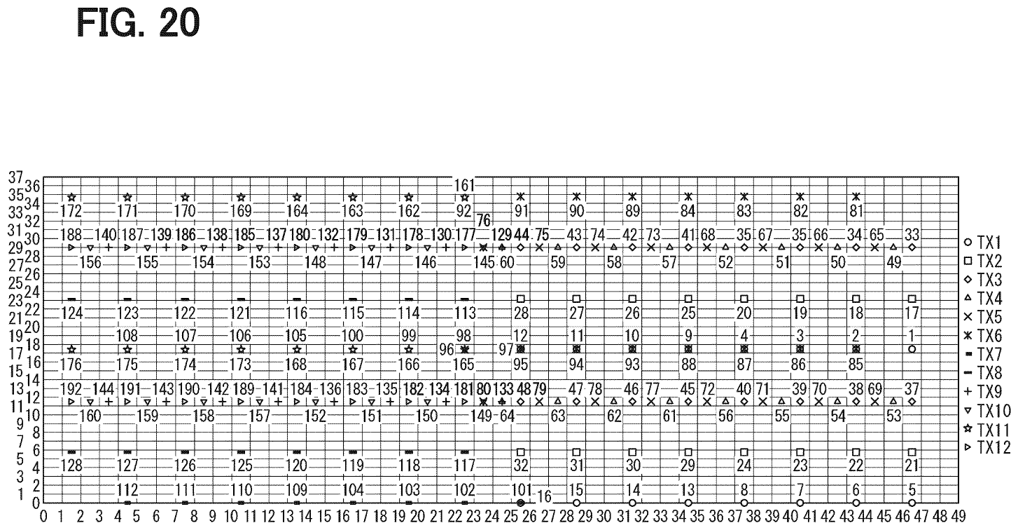

For each of the twelve transmission antennas TX, sixteen virtual antennas V are assumed, corresponding to the number of reception antennas RX. Therefore, a total of 192 virtual antennas V are assumed. Specifically, as shown in FIG. 20, the 192 virtual antennas V are assumed to be arranged in such a configuration.

Hereinafter, among the sixteen virtual antennas V assumed for a specific transmission antenna TXp, the virtual antenna V corresponding to a specific reception antenna RXq (where p and q are natural numbers) is denoted as Vu (u=(p−1)×16+q). Note that, in FIG. 20, the letter “V” is omitted to avoid complexity.

As shown in FIG. 20, there are 24 sets of virtual antennas V with overlapping virtual positions. Among these, there are 13 unique sets in which the combination of transmission circuit 3 and reception circuit 4 does not overlap with other sets. For example, (V2, V85), (V9, V88), (V10, V93), (V12, V97), (V16, V86), (V60, V129), (V64, V133), (V76, V145), (V80, V149), (V95, V97), (V98, V165), (V105, V168), and (V106, V173) can be assumed as unique sets. The compensation unit 64, described later, executes compensation processing based on the reception signals obtained at at least six sets of these virtual antennas V.

Note that, as sets of virtual antennas V assumed for the compensation processing, other sets in which the combination of transmission circuit 3 and reception circuit 4 does not overlap with other sets may also be assumed. For example, (V3, V86) and (V4, V87) overlap in the combination of transmission circuit 3 and reception circuit 4 with (V2, V85), but do not overlap with other sets. Therefore, assuming (V3, V86) or (V4, V87) as one of the 13 sets is equivalent to assuming (V2, V85).

Here, since Ns=4 and Nr=4, the control unit 6 calculates the phase error and amplitude error from the beat signals of at least seven sets among the belonging sets in the processing of S80 and S90. Specifically, the control unit 6 calculates the phase error and amplitude error between transmission circuits 3, the phase error and amplitude error between reception circuits 4, and the phase error and amplitude error corresponding to the wiring length difference.

Note that, as described above, when the number of antennas TX and RX is relatively large, the arrangement of antennas TX and RX can be determined by a genetic algorithm. For example, as characteristics for evaluating the current generation generated by the genetic algorithm, overlap efficiency, rank, wiring efficiency, FOV, and separation angle can be mentioned. The overlap efficiency is a parameter obtained by dividing the full rank number by the number of channel reductions due to overlapping virtual positions, and it is desirable for this to be large. The rank is a predetermined parameter. The wiring efficiency is a parameter according to the variance of antenna coordinates input to the same circuit, and it is desirable for this to be small. The FOV is a parameter according to the interval between antennas, and it is desirable for this to be small. The separation angle is a parameter according to the aperture length, and it is desirable for this to be large.

### OTHER EMBODIMENTS

The above description has explained a plurality of embodiments, but the present disclosure is not to be interpreted as being limited to these embodiments, and can be applied to various embodiments and combinations thereof within the scope not departing from the gist of the present disclosure.

In a modification, the diagnosis unit 66 may diagnose a failure of the temperature sensor 5 based on a comparison of the change patterns of each temperature information, rather than the temperature difference between the sensor temperature information and the phase temperature information. For example, the diagnosis unit 66 may diagnose that the temperature sensor 5 has failed when the difference between the amounts of change in each temperature information from the previous detection exceeds a threshold value.

In a modification, the temperature detection unit 65 may acquire temperature information corresponding to the relative amplitude error. Since the parameter α used in the calculation of the relative amplitude error, like parameter K, is a value corresponding to temperature, the temperature detection unit 65 can acquire temperature information from the correlation between parameter α and temperature. In this case, the diagnosis unit 66 may acquire the relative amplitude error between transmission circuits 3 and between reception circuits 4 according to the temperature information in S180. Furthermore, in S190, the diagnosis unit 66 may determine whether the amplitude error difference, which is the difference between the relative amplitude error according to the temperature information and the relative amplitude error based on the reception result acquired in S90, is within the allowable error difference range as the difference range for the relative amplitude error. In this modification, the relative amplitude error is an example of “error information.”

In a modification of the fourth embodiment, both the transmission antennas TX and the reception antennas RX may be arranged at unequal intervals.

In a modification, the dedicated computer constituting the control unit 6 may be a sensor integration ECU that integrally controls a plurality of types of sensors mounted on a vehicle. The dedicated computer constituting the control unit 6 may be an integrated ECU that integrates vehicle driving control. The dedicated computer constituting the control unit 6 may be a judgment ECU that determines driving tasks in vehicle driving control. The dedicated computer constituting the control unit 6 may be a monitoring ECU that monitors vehicle driving control. The dedicated computer constituting the control unit 6 may be an evaluation ECU that evaluates vehicle driving control.

The dedicated computer constituting the control unit 6 may be a navigation ECU that navigates the travel route of the vehicle. The dedicated computer constituting the control unit 6 may be a locator ECU that estimates the self-state quantities of the vehicle. The dedicated computer constituting the control unit 6 may be an actuator ECU that controls the travel actuators of the vehicle. The dedicated computer constituting the control unit may be an HCU (HMI (Human Machine Interface) Control Unit) that controls information presentation in the vehicle. The dedicated computer constituting the control unit 6 may be a computer other than the vehicle, such as an external center or mobile terminal capable of communicating with the vehicle.

In a modification, the mobile object to which the radar device 1 is applied may be, for example, an autonomous device (autonomous robot) capable of cargo transport or information collection by autonomous driving or remote driving. The autonomous device (autonomous robot) includes, for example, an autonomous vehicle. In addition to the above-described embodiments, the above embodiments and modifications may be implemented as a control device mountable on a mobile object, having at least one processor 6b and at least one memory 6a. Specifically, the above embodiments and modifications may be implemented in the form of a processing circuit (for example, a processing ECU, etc.) or a semiconductor device (for example, a semiconductor chip, etc.).

What is claimed is:

1. A radar device comprising:
a plurality of transmission antennas;
a plurality of reception antennas;
a number Ns of transmission circuits connected to the transmission antennas and configured to output a transmission signal;
a number Nr of reception circuits connected to the reception antennas and configured to acquire reception signals;
a control unit configured to process the reception signals; and
a housing unit configured to house the transmission antennas, the reception antennas, the transmission circuits, the reception circuits, and the control unit;
wherein
Ns and Nr are each integers of 2 or more,
the plurality of the transmission antennas and the plurality of the reception antennas are arranged such that:
(i) at least one of the plurality of the transmission antennas and the plurality of the reception antennas is arranged at unequal intervals;
(ii) among a group of virtual antennas assumed for each transmission antenna with respect to the plurality of reception antennas according to a phase difference of the reception signals between the reception antennas, in a collection of sets of the virtual antennas in which virtual positions overlap and a combination of a transmission circuit and a reception circuit do not match, there are included at least Ns+Nr−2 unique sets of virtual antennas, each being a set in which a combination of a transmission circuit and a reception circuit does not overlap with any other set;
(iii) at least one different wiring length set is included, which is a set of virtual antennas with overlapping virtual positions and different wiring lengths; and
(iv) a total number of belonging sets, which are sets of virtual antennas belonging to at least one of the unique sets and the different wiring length set, is at least Ns+Nr−1 sets,
the control unit includes:
an error acquisition unit configured to acquire error information relating to at least one of the phase difference and amplitude difference of the reception signals corresponding to a wiring length difference between the virtual antennas, based on a comparison result of the reception signals between the virtual antennas in the at least Ns+Nr−1 belonging sets; and
an estimation unit configured to estimate temperature information related to internal temperature of the housing unit according to the error information.

2. The radar device according to claim 1, further comprising
a temperature sensor that detects temperature information by a method different from an estimation based on the error information,
wherein
the control unit further includes a diagnosis unit configured to diagnose failure of the temperature sensor in accordance with a comparison result between the temperature information estimated by the estimation unit and the temperature information detected by the temperature sensor.

3. The radar device according to claim 2, wherein
the diagnosis unit outputs notification information indicating failure of the temperature sensor when it is determined that the temperature sensor is malfunctioning.

4. The radar device according to claim 1, wherein
the error acquisition unit further acquires a phase difference between different transmission circuits, and
the control unit includes a diagnosis unit configured to diagnose failure of the transmission circuit in accordance with a comparison result between the phase difference between the different transmission circuits corresponding to the temperature information and the phase difference between transmission circuits acquired by the error acquisition unit.

5. The radar device according to claim 1, wherein
the error acquisition unit further acquires a phase difference between different reception circuits, and
the control unit includes a diagnosis unit configured to diagnose failure of the reception circuit in accordance with a comparison result between the phase difference between the different reception circuits corresponding to the temperature information and the phase difference between the reception circuits acquired by the error acquisition unit.

6. The radar device according to claim 1, wherein
the transmission antennas and the reception antennas are arranged such that a wiring length difference between the virtual antennas in the belonging sets reaches an allowable difference range.

7. A radar device comprising:
a plurality of transmission antennas arranged at equal intervals;
a plurality of reception antennas arranged at equal intervals;
a number Ns of transmission circuits connected to the transmission antennas and configured to output a transmission signal;
a number Nr of reception circuits connected to the reception antennas and configured to acquire reception signals;
a control unit configured to process the reception signals;
a housing unit configured to house the transmission antennas, the reception antennas, the transmission circuits, the reception circuits, and the control unit,
wherein
Ns and Nr are each integers of 2 or more;
the plurality of the transmission antennas and the plurality of the reception antennas are arranged such that:
(i) among groups of virtual antennas assumed for each transmission antenna with respect to the plurality of reception antennas according to a phase difference of the reception signals between the reception antennas, in a collection of sets of the virtual antennas in which virtual positions overlap and a combination of a transmission circuit and a reception circuit do not match, there are included at least Ns+Nr−2) unique sets of virtual antennas, each being a set in which a combination of the transmission circuit and the reception circuit does not overlap with any other set;
(ii) at least one different wiring length set is included, which is a set of virtual antennas with overlapping virtual positions and different wiring lengths; and
(iii) a total number of belonging sets, which are sets of virtual antennas belonging to at least one of the unique sets and the different wiring length set, is at least Ns+Nr−1 sets,
the control unit includes:
an error acquisition unit configured to acquire error information relating to at least one of the phase difference and amplitude difference of the reception signals corresponding to a wiring length difference between the virtual antennas, based on a comparison result of the reception signals between the virtual antennas in at least Ns+Nr−1 belonging sets;
an estimation unit configured to estimate temperature information related to internal temperature of the housing unit according to the error information.

8. The radar device according to claim 7, further comprising
a temperature sensor that detects temperature information by a method different from an estimation based on the error information,
wherein
the control unit further includes a diagnosis unit configured to diagnose failure of the temperature sensor in accordance with a comparison result between the temperature information estimated by the estimation unit and the temperature information detected by the temperature sensor.

9. The radar device according to claim 8, wherein
the diagnosis unit outputs notification information indicating failure of the temperature sensor when it is determined that the temperature sensor is malfunctioning.

10. The radar device according to claim 7, wherein
the error acquisition unit further acquires a phase difference between different transmission circuits, and
the control unit includes a diagnosis unit configured to diagnose failure of the transmission circuit in accordance with a comparison result between the phase difference between the different transmission circuits corresponding to the temperature information and the phase difference between transmission circuits acquired by the error acquisition unit.

11. The radar device according to claim 7, wherein
the error acquisition unit further acquires a phase difference between different reception circuits, and
the control unit includes a diagnosis unit configured to diagnose failure of the reception circuit in accordance with a comparison result between the phase difference between the different reception circuits corresponding to the temperature information and the phase difference between the reception circuits acquired by the error acquisition unit.

12. The radar device according to claim 7, wherein
the transmission antennas and the reception antennas are arranged such that a wiring length difference between the virtual antennas in the belonging sets reaches an allowable difference range.
